(19) United States
(12) Patent Application Publication
(10) Pub. No.: US 2026/0092582 A1
(43) Pub. Date: Apr. 2, 2026

(54) POWERTRAIN SYSTEM FOR A VEHICLE

(71) Applicant: VOLVO TRUCK CORPORATION, Göteborg (SE)

(72) Inventor: Johan Karlsson, Göteborg (SE)

(73) Assignee: VOLVO TRUCK CORPORATION, Göteborg (SE)

(21) Appl. No.: 19/341,516

(22) Filed: Sep. 26, 2025

(30) Foreign Application Priority Data
Oct. 1, 2024 (EP) 24204016.0

(51) Int. Cl. F02M 21/02; F04B 49/02

(52) U.S. Cl. CPC F02M 21/0245; F02M 21/0221; F04B 49/02; F02M 21/0206; F02M 21/0215

(57) ABSTRACT

A powertrain system has an internal combustion engine operable on a gaseous fuel; a gaseous fuel tank system having a set of gaseous fuel tanks for storing pressurized gaseous fuel, the gaseous fuel tank system being configured to be in fluid communication with the engine; a compressor assembly for pressurizing gaseous fuel. The powertrain system is operable in a first mode where gaseous fuel is supplied from at least one of the gaseous fuel tanks to the engine in a non-operational mode of the compressor assembly, and in a second mode where gaseous fuel from at least one of the gaseous fuel tanks is pressurized by the compressor assembly in an operational mode of the compressor assembly and supplied to the engine. A controller predicts an expected operational change of the powertrain system based on route information describing at least one route segment for an intended route of the vehicle, to control the compressor assembly based on the predicted expected operational change.

### TECHNICAL FIELD

The disclosure relates generally to powertrain systems for vehicles. In particular aspects, the disclosure relates to powertrain systems having an internal combustion engine operable on a gaseous fuel, such as a hydrogen-based fuel. In other aspects, the disclosure relates to a vehicle comprising such a powertrain system. The disclosure can be applied to heavy-duty vehicles, such as trucks, buses, and construction equipment, among other vehicle types. Although the disclosure may be described with respect to a particular vehicle, the disclosure is not restricted to any particular vehicle.

### BACKGROUND

The utilization of alternative fuels, such as hydrogen gas and natural gas, as clean and sustainable fuel components for internal combustion engines is one of the many examples considered in the heavy-duty vehicle industry.

However, using alternative fuels in a vehicle may present several new challenges to the powertrain system of the vehicle, including the internal combustion engine (ICE) and the fuel supply system, in comparison with more traditional fuels.

One of these challenges relates to the supply of fuel from the fuel tank(s) to the ICE. By way of example, conventional hydrogen fuel storage systems for heavy-duty vehicles may generally include one or more high-pressure fuel tanks. However, the fuel injection processes in the ICE system may occur at substantially lower pressures. In other words, the fuel, such as pressurized hydrogen gas, needs to be delivered to the ICE at a suitable pressure level. There is thus a need for further development to provide efficient delivery of pressurized hydrogen gas to the ICE of a heavy-duty vehicle.

### SUMMARY

According to a first aspect of the disclosure, there is provided a powertrain system for a vehicle, the powertrain system comprising an internal combustion engine operable on a gaseous fuel; a gaseous fuel tank system having a set of gaseous fuel tanks for storing pressurized gaseous fuel, the gaseous fuel tank system being configured to be in fluid communication with the engine; and a compressor assembly for pressurizing gaseous fuel. Moreover, the powertrain system is operable in a first powertrain operational mode where gaseous fuel is supplied from at least one of the gaseous fuel tanks to the engine in a non-operational mode of the compressor assembly, and in a second powertrain operational mode where gaseous fuel from at least one of the gaseous fuel tanks is pressurized by the compressor assembly in an operational mode of the compressor assembly and supplied to the engine. In addition, the powertrain system comprises a controller configured to predict an expected operational change of the powertrain system based on route information describing at least one route segment for an intended route of the vehicle, and, determine to control the compressor assembly based on the predicted expected operational change.

The first aspect of the disclosure may seek to enhance the efficiency of a powertrain system for a vehicle including at least an internal combustion engine operable on a gaseous fuel and a compressor assembly. A technical benefit may include improving the utilization of the compressor assembly, based on the predicted expected operational change in the operating conditions of the powertrain system, typically referring to changes in the operation of the ICE. More specifically, the configuration of the controller to predict changes in the operation of the powertrain system based on route information and to decide whether to engage the compressor provides for enhancing the utilization of the compressor, ensuring that the compressor operates only when beneficial to the overall efficiency of the powertrain. To this end, the proposed configuration of the controller contributes to reducing fuel consumption by avoiding unnecessary compressor operation.

In particular, by predicting the expected operational change of the powertrain system using route information that describes at least one route segment for an intended route of the vehicle, the controller can determine whether to control the compressor assembly. By basing the control decision on the predicted change, the likelihood of engaging the compressor only when associated energy costs are minimized, or at least reduced, is increased. Such an approach may lead to improved utilization of the compressor assembly, enhancing energy efficiency.

In addition, the proposed disclosure allows for providing a more dynamic and precise regulation of the fuel from the fuel tanks to the ICE, based on predicted changes in the engine operating conditions.

The proposed powertrain system further allows for better determination of the optimal conditions for enhanced efficiency of the ICE and the powertrain system by assessing the impact of operating the compressor assembly to attain the requisite gas pressure rather than directly sourcing it from fuel tanks. As such, the compressor assembly can be controlled in a more precise and predictive manner, including such as detecting an upcoming operating situation where increased efficiency of the powertrain system is foreseeable, where activating the compressor may become a priority.

In addition, the proposed powertrain system may provide for improving the use of the pressurized fuel during varying operating conditions of the ICE and the vehicle.

The powertrain system may be particularly useful in combination with an engine in the form of a high-pressure direct injection fuel system. Hence, the powertrain system may typically comprise an internal combustion engine in the form of a high-pressure direct injection internal combustion engine. The powertrain system may in addition, or alternatively be used in combination with a spark-ignited internal combustion engine, such as a spark-ignited high pressure direct inject internal combustion engine or a diffusion combustion internal combustion engine.

Typically, the controller is also configured to control the compressor assembly based on the determined control, which includes controlling the compressor assembly either in the operational mode or in the non-operational mode.

Optionally in some examples, including in at least one preferred example, determine to control the compressor assembly based on the predicted expected operational change of the powertrain system may comprise determining whether to operate the compressor assembly in the operational mode, switch from the non-operational mode to the operational mode, remain in the non-operational mode, or switch from the operational mode to the non-operational mode. A technical benefit may include further improving the control of the compressor assembly. By selectively determining whether to operate, switch, or remain in either the operational or non-operational mode, the system may avoid, or at least reduce unnecessary activation of the compressor, thus reducing energy consumption and improving the overall efficiency of the powertrain system. Such selective control also reduces wear on the compressor assembly, contributing to enhanced system longevity and reduced maintenance costs.

Optionally in some examples, including in at least one preferred example, the controller may be configured to determine whether to operate the compressor assembly in the operational mode, switch from the non-operational mode to the operational mode, remain in the non-operational mode, or switch from the operational mode to the non-operational mode by determining whether operating the compressor assembly will increase or decrease powertrain system efficiency in the at least one route segment. By determining whether the compressor will increase or decrease powertrain system efficiency in specific route segments, the system can dynamically adjust its operation to maintain efficiency, further reducing fuel consumption in varying driving conditions.

Optionally in some examples, including in at least one preferred example, the controller may be configured to determine to control the compressor assembly by determining a first powertrain system efficiency for operating the powertrain system in the first powertrain operational mode in the at least one route segment and a second powertrain system efficiency for operating the powertrain system in the second powertrain operational mode in the at least one route segment, compare the first powertrain system efficiency and the second powertrain system efficiency, and select the operational mode with the determined highest powertrain system efficiency. Comparing the efficiencies of different operational modes for the same route segment allows the controller to select the most efficient mode. A technical benefit may include a more precise comparison in deciding how the compressor can be used in a manner that enhances fuel efficiency.

Optionally in some examples, including in at least one preferred example, the route information may contain any one of an indication of a speed limit, a road type, a road elevation profile, construction work, and traffic flow. Utilizing detailed route information such as speed limits, road type, and elevation profile allows the controller to make more informed decisions about the compressor use. A technical benefit may include better anticipation of fuel needs, improving the timing of compressor operation and thus enhancing fuel efficiency.

Optionally in some examples, including in at least one preferred example, the controller may be further configured to predict the expected operational change of the powertrain system based on a previous powertrain system operating profile for the route segment. By considering previous powertrain system operating profiles for the same route segment, the controller can more accurately predict future efficiency outcomes. A technical benefit may include further improving the control of the compressor in terms of efficiency and overall fuel consumption.

Optionally in some examples, including in at least one preferred example, the controller may further be configured to obtain route information indicative of an intended route for the vehicle.

Optionally in some examples, including in at least one preferred example, the controller may further be configured to determine a current powertrain system efficiency and determine to control the compressor assembly based on a comparison between the determined current powertrain system efficiency and a predicted powertrain system efficiency in the at least one route segment. A technical benefit may include further improving the control of the compressor in terms of efficiency and overall fuel consumption.

Optionally in some examples, including in at least one preferred example, the controller may be configured to predict the expected operational change of the powertrain system by determining any one of an expected operational change in engine load, engine torque, engine revolution and engine acceleration in the at least one route segment. A technical benefit may include further improving the precision of predicting the expected operational change of the powertrain system.

Optionally in some examples, including in at least one preferred example, the predictive information may be generated based on historical route data for the intended route for the vehicle. Using historical route data to generate predictive information may further improve the accuracy of the decision of the controller. A technical benefit may include an even more efficient compressor use, especially on familiar routes, thereby enhancing fuel efficiency.

Optionally in some examples, including in at least one preferred example, the powertrain system may further comprise a buffer tank arranged between the engine and the gaseous fuel tanks, wherein the buffer tank stores fuel compressed by the compressor assembly, for use during conditions where operating the compressor assembly is predicted to decrease engine efficiency. The inclusion of a buffer tank allows for storing pressurized fuel during periods of low demand, ensuring that the compressor is not operated inefficiently. Such storage capability may reduce the need for compressor operation during high fuel demand periods, further improving fuel efficiency.

Optionally in some examples, including in at least one preferred example, the controller may further be configured to prioritize the operation of the compressor assembly when the predicted expected operational change of the powertrain system is indicative of engine load conditions favoring increased efficiency from pressurized fuel supply.

Prioritizing compressor operation based on predictive information about engine load conditions may further ensure that pressurized fuel is used most effectively. Such prioritization may reduce fuel wastage during high demand periods, contributing to better overall fuel efficiency.

Optionally in some examples, including in at least one preferred example, the controller may further be configured to conserve pressurized fuel in the gaseous fuel tanks for use during high engine power demands where compressor assembly operation would be less efficient, based on comparison with a reference threshold value.

Optionally in some examples, including in at least one preferred example, the controller may be configured to control the use of the buffer tank by filling it with excess pressurized fuel produced by the compressor assembly during periods predicted to have low engine fuel consumption, and to utilize the stored pressurized fuel during periods where operating the compressor assembly is predicted to decrease powertrain system efficiency. Controlling the buffer tank to store excess pressurized fuel during periods of low consumption may allow the system to reduce compressor operation during inefficient periods.

Optionally in some examples, including in at least one preferred example, the controller may be configured to deplete the buffer tank prior to an anticipated engine braking event, and to operate the compressor assembly during the engine braking to refill the buffer tank without consuming additional fuel. Depleting the buffer tank before an anticipated engine braking event and refilling it during braking may further improve the use of free energy, reducing the overall fuel consumption by reducing the need to operate the compressor under less efficient conditions. An anticipated engine braking event may be identified using topography data, such as identifying a downhill descent.

Optionally in some examples, including in at least one preferred example, the controller may be configured to deplete the buffer tank prior to an anticipated motoring event, and to operate the compressor assembly during the motoring to refill the buffer tank without consuming additional fuel.

Optionally in some examples, including in at least one preferred example, the controller may be configured to receive data indicative of pressure levels in one or more gaseous fuel tanks of the set of gaseous fuel tanks.

Optionally in some examples, including in at least one preferred example, the controller may be further configured to determine pressure levels of each one of the gaseous fuel tanks of the set of gaseous fuel tanks.

Optionally in some examples, including in at least one preferred example, the controller may be further configured to determine a powertrain system efficiency parameter for the first powertrain operational mode based on data indicative of pressure levels of each one of the gaseous fuel tanks, and determine a corresponding powertrain system efficiency parameter for the second powertrain operational mode based on data indicative of pressure levels of each one of the gaseous fuel tanks and a needed power output from the internal combustion engine for operating the compressor assembly to provide a predetermined pressure fuel level. A technical benefit may include providing an even more improved determination of the available pressure levels of the fuel tanks, in which all fuel tanks are taken into consideration.

Optionally in some examples, including in at least one preferred example, the controller may be configured to predict the compressor assembly power demand for the at least one route segment of the route ahead of the vehicle.

Optionally in some examples, including in at least one preferred example, the controller may further be configured to control the operation of the compressor assembly.

Optionally in some examples, including in at least one preferred example, the route information may be obtained from topography data, such as GPS data.

Optionally in some examples, including in at least one preferred example, the compressor assembly may be a reciprocating compressor having a compressor cylinder for accommodating a compressor piston. A technical benefit may include facilitating the installation and operation of the compressor assembly in a powertrain system for gaseous fuels, such as hydrogen gas.

Optionally in some examples, including in at least one preferred example, the compressor assembly may be arranged in a gaseous fuel conduit in-between the engine and the gaseous fuel tank system. A technical benefit may include providing an improved arrangement of the compressor assembly in the powertrain system, allowing for an increased efficiency of the compressor assembly for pressurizing the fuel from the fuel tank(s).

Optionally in some examples, including in at least one preferred example, the compressor assembly may be arranged in-between the engine and a first gaseous fuel tank of the gaseous fuel tank system.

Optionally in some examples, including in at least one preferred example, the gaseous fuel may be a hydrogen-based fuel or a natural gas fuel. A technical benefit may include utilization of a fuel having a high energy density, which for hydrogen gas (H2) is approximately 120 MJ/kg and for natural gas (NG) is approximately 55 MJ/kg.

Optionally in some examples, including in at least one preferred example, the fuel may be hydrogen gas or natural gas.

Optionally in some examples, including in at least one preferred example, the engine may be a spark-ignited internal combustion engine. In addition, the engine may be a high-pressure direct injected internal combustion engine.

The internal combustion engine may be a hydrogen internal combustion engine, such as a hydrogen high-pressure direct injection internal combustion engine, wherein the fuel tanks(s) may be arranged to supply pressurized hydrogen gas to the internal combustion engine.

Optionally in some examples, including in at least one preferred example, the fuel tanks may be configured to store pressurized gaseous fuel at about 700 to 800 bar. For example, the fuel tanks are arranged to maintain the pressurized gaseous fuel at a maximum pressure of 800 bar. For example, the fuel tanks are arranged to store the pressurized gaseous fuel between 700 bar and 800 bar.

Optionally in some examples, including in at least one preferred example, the fuel stored in the fuel tanks is mainly gaseous fuel. For example, at least 70 %, or at least 80 %, or at least 90 %, or at least 95 % (based on volume) of the fuel in the fuel tanks is gaseous. Thus, the fuel tanks are arranged to store the fuel as pressurized gaseous fuel such that at least 70 %, or at least 80 %, or at least 90 %, or at least 95 % (based on volume) of the fuel in the fuel tanks is gaseous.

Optionally in some examples, including in at least one preferred example, the compressor assembly may be configured to at least partly be powered by the internal combustion engine.

Optionally in some examples, including in at least one preferred example, the compressor assembly may be configured to be solely powered by the internal combustion engine.

Optionally in some examples, including in at least one preferred example, the compressor assembly may be configured to at least partly be powered by an auxiliary power source. Typically, the auxiliary power source is a different power source than the engine.

According to a second aspect of the disclosure, there is provided a vehicle comprising a powertrain system according to the first aspect of the disclosure is provided. The second aspect of the disclosure may seek to solve the same problem as described for the first aspect of the disclosure. Thus, effects and features of the second aspect of the disclosure are largely analogous to those described above in connection with the first aspect of the disclosure.

Optionally in some examples, including in at least one preferred example, the vehicle further comprises an engine in the form of a hydrogen combustion engine or a hydrogen high-pressure direct injection engine. The engine is configured to receive the pressurized fuel from the fuel tank(s) for combustion inside the engine. For example, the powertrain system may comprise a fuel rail arrangement disposed upstream of one or more fuel injectors of the engine, wherein the fuel rail arrangement may be arranged to supply pressurized gaseous fuel to the fuel injector(s) of the engine.

According to a third aspect of the disclosure, there is provided a method for controlling a compressor assembly of a powertrain system for a vehicle. Moreover, the method is implemented by a controller having a processing circuitry, wherein the method comprises: predicting, by processing circuitry of a controller, an expected operational change of the powertrain system based on route information describing at least one route segment for an intended route of the vehicle, and determining, by the processing circuitry of the controller, to control the compressor assembly based on the predicted expected operational change of the powertrain system.

The third aspect of the disclosure may seek to solve the same problem as described for the first to second aspects of the disclosure. Thus, effects and features of the third aspect of the disclosure are largely analogous to those described above in connection with the first and second aspects of the disclosure.

According to a fourth aspect of the disclosure, there is provided a computer program product comprising program code for performing, when executed by the processing circuitry comprised in the controller of the first aspect, the method of the third aspect.

According to a fifth aspect of the disclosure, there is provided a non-transitory computer-readable storage medium comprising instructions, which when executed by the processing circuitry of the first aspect, cause the processing circuitry to perform the method of the third aspect.

The disclosed aspects, examples (including any preferred examples), and/or accompanying claims may be suitably combined with each other as would be apparent to anyone of ordinary skill in the art. Additional features and advantages are disclosed in the following description, claims, and drawings, and in part will be readily apparent therefrom to those skilled in the art or recognized by practicing the disclosure as described herein.

### BRIEF DESCRIPTION OF THE DRAWINGS

FIG. 1 schematically illustrates an exemplary vehicle comprising a powertrain system, including at least an internal combustion engine, gaseous fuel tank system and a compressor assembly, according to an example.

FIG. 2 schematically illustrates another exemplary vehicle comprising a powertrain system, including at least an internal combustion engine, gaseous fuel tank system and a compressor assembly, according to an example.

FIG. 3 is an illustrative example of the vehicle with the powertrain system of FIGS. 1 or 2, in which the vehicle travels along a route and the powertrain system is operated according to an example.

FIG. 4 is another illustrative example of the vehicle with the powertrain system of FIGS. 1 or 2, in which the vehicle travels along a route and the powertrain system is operated according to an example.

FIG. 5 is a flow chart of an exemplary method to control a powertrain system of a vehicle according to an example.

FIG. 6 is a schematic diagram of an exemplary computer system for implementing examples disclosed herein, according to an example.

### DETAILED DESCRIPTION

The detailed description set forth below provides information and examples of the disclosed technology with sufficient detail to enable those skilled in the art to practice the disclosure.

The present disclosure is at least partly based on the insight that powertrain systems for vehicles including an internal combustion engine operating on gaseous fuels, such as a hydrogen-based gas fuel or natural gas fuel, e.g. LNG or CNG, may be an attractive alternative to traditional gasoline or diesel-powered engines. Such systems may produce fewer harmful emissions compared to gasoline and diesel. For ease of reference, the term gaseous fuel may be referred to simply as the fuel.

However, despite the progress in the industry, there is still a challenge in delivering the fuel to the engine in an efficient manner and at a correct pressure. Purely by way of example, conventional hydrogen fuel storage systems for heavy-duty vehicles may include one or more high-pressure tanks, typically pressurized at about 700 bar. Such types of ICE systems may typically also utilize a high-pressure direct injection fuel system, and may thus be denoted as a high-pressure direct injection ICE system. Moreover, a high-pressure direct injection ICE running on gaseous fuel may typically require a high enough fuel pressure to be effective and to enable peak power output. While the fuel tanks are initially pressurized with high enough pressure to enable the ICE to operate in an efficient manner, the pressure in the tanks will eventually decrease as the fuel is used by the ICE and the tanks are emptied. When the pressure in the tanks is too low to ensure the operation of the ICE, the fuel needs to be pressurized by a compressor to achieve high efficiency and peak power from the ICE.

Moreover, in such ICE systems, e.g. high-pressure direct injection ICE systems, the compressor may typically be powered by the ICE and/or another power source, such as a generator and/or a hydraulic system. Therefore, additional power is required from the powertrain system, such as from the ICE, when the compressor is operated and powered by the powertrain system. At certain operating points, the extra power demand from the compressor can result in a loss of efficiency in the powertrain system. For example, the ICE may typically not have a constant efficiency. Rather, the efficiency of the ICE may typically vary with ICE speed and ICE torque. It should be noted that the compressor assembly may, in some examples, be indirectly powered by the ICE, e.g. by the means of a hydraulic pump coupled to the ICE, which in turn powers the compressor.

To this end, there is a disadvantage in operating the compressor if strictly not needed, i.e. operating the compressor in a non-strategic way, as it may lead to reduced efficiency of the ICE, and thus leading to shorter range of the vehicle.

One example of operating the powertrain system to overcome the aforementioned challenge could involve utilizing gas directly from the fuel tanks until the pressure falls below the required level for the ICE, at which point the compressor would be activated. However, operating the compressor in this manner may result in a reduction of ICE efficiency at certain operating points, thereby decreasing the overall efficiency of the powertrain system and reducing the range of the vehicle.

For these and other reasons, there is still a need for improving the operation of the compressor assembly in a powertrain system having a gaseous ICE and a set of fuel tanks.

To remedy this, the present disclosure provides a powertrain system and methods using a compressor assembly to pressurize a gaseous fuel based on predicted changes ahead of the vehicle.

The disclosure may thus seek to enhance the efficiency of a powertrain system for a vehicle including at least an internal combustion engine operable on a gaseous fuel and a compressor assembly. A technical benefit may include improving the utilization of the compressor assembly, based on the predicted expected operational change in the operating conditions of the powertrain system, typically referring to changes in the operation of the ICE. More specifically, the configuration of the controller to predict changes in the operation of the powertrain system based on route information and to decide whether to engage the compressor provides for enhancing the utilization of the compressor, ensuring that the compressor operates only when beneficial to the overall efficiency of the powertrain. To this end, the proposed configuration of the controller contributes to reducing fuel consumption by avoiding unnecessary compressor operation.

The disclosure of the vehicle and the powertrain system may be particularly useful in applications where the ICE is combined with a high-pressure direct injection fuel system. Hence, the powertrain system may typically comprise an internal combustion engine in the form of a high-pressure direct injection internal combustion engine. The powertrain system may in addition, or alternatively be used in combination with a spark-ignited internal combustion engine, such as a spark-ignited high pressure direct inject internal combustion engine or a diffusion combustion internal combustion engine.

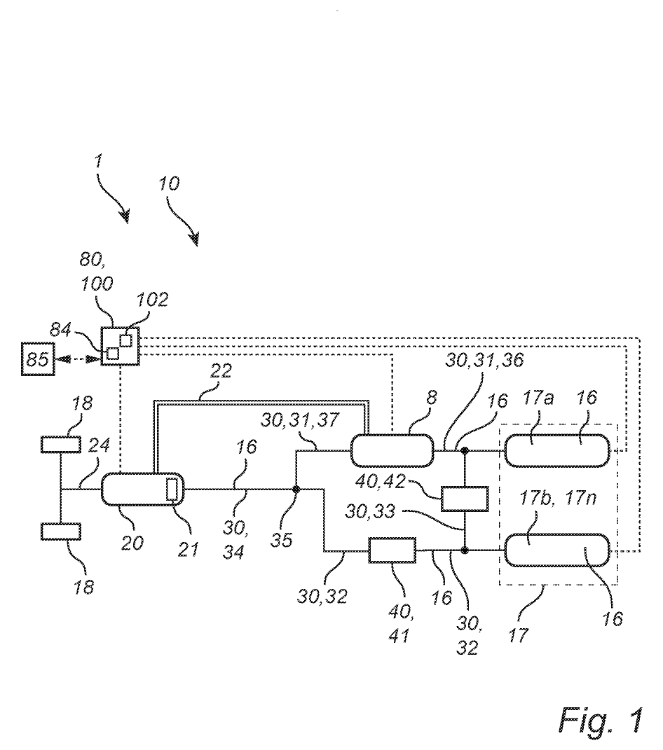

FIG. 1 schematically illustrates a vehicle 1 in the form of an exemplary heavy-duty truck. It should be noted that the vehicle may be any type of vehicle suitable for transporting goods, materials and/or people, such as bulk material from one location to another. For example, the vehicle 1 may be an excavator, a loader, an articulated hauler, a dump truck, a truck or any other suitable vehicle known in the art. In some embodiments, the vehicle 1 may be driven by an operator. In other embodiments, the vehicle 1 may be an autonomous vehicle that is controlled by a vehicle motion management (VMM) unit configured to individually control vehicle units and/or vehicle axles and/or wheels of the vehicle. For ease of reference, the following description refers to vehicles in the form of heavy-duty vehicles, such as trucks.

The vehicle 1 illustrated in FIG. 1 comprises a powertrain system 10. The powertrain system 10 comprises an internal combustion engine (ICE) 20. Throughout the description of the powertrain system, the ICE may be denoted as the internal combustion engine, the combustion engine or simply as the engine. The ICE 20 is configured to provide power for propelling the vehicle 1. The ICE 20 is configured to be connected to one or more ground engaging members 18, such as one or more wheels of the vehicle 1, as illustrated in FIG. 1. The ICE 20 is here operatively connected to one or more ground engaging members 18 by a powertrain shaft assembly 24. In this manner, torque from the ICE 20 can be transferred to the ground engaging members 18.

The ICE 20 is an ICE configured to be operable on a gaseous fuel 16. By way of example, the gaseous fuel is a hydrogen-based fuel. In one example, the ICE 20 is operable on pure hydrogen gas as the main fuel component. In another example, the ICE 20 is operable on pure hydrogen gas as the only fuel component.

Hence, the ICE 20 is here a hydrogen ICE. In a hydrogen ICE, the ICE 20 is configured to combust the pressurized gaseous fuel in the form of pressurized hydrogen. Such combustion process of hydrogen produces water as by-product in the exhausts. The ICE 20 may e.g. be a pure hydrogen ICE, such as a hydrogen high-pressure direct injection ICE. In other examples, the ICE 20 is a hydrogen-based ICE operating on a mix of hydrogen fuel and another fuel, such as diesel fuel. In other examples, the ICE 20 is a natural gas ICE, i.e. an ICE configured to be operable on a natural gas fuel. Hence, the ICE 20 is operable on a gaseous fuel 16. These types of ICEs are commonly known in the art, and thus not further described herein.

As is commonly known in the art, the ICE 20 generally comprises one or more cylinders having corresponding combustion chambers and reciprocating pistons. Such type of ICE 20 also comprises a fuel injection system having one or more fuel injectors for injecting the pressurized gaseous fuel into the one or more cylinder. In order to deliver the fuel to the fuel injector(s), the ICE 20 may also comprise a so-called fuel rail arrangement 21, as schematically illustrated in FIG. 1. In this context, a fuel rail arrangement 21 refers to a component in the fuel injection system that delivers pressurized fuel to the fuel injectors. The purpose of the fuel rail arrangement 21 is to distribute fuel evenly to the injectors, which then spray the fuel into the combustion chambers. The fuel rail arrangement 21 is typically integrated into the ICE 20 and can be partly or fully mounted on, or in, the ICE 20. The fuel rail arrangement 21 is configured to connect to the fuel injectors through short fuel lines. The fuel rail arrangement 21 is arranged and configured to maintain a certain pressure to ensure proper fuel atomization and combustion in the ICE 20. The pressure of the fuel can further be regulated by a fuel pressure regulator in the ICE 20 before final deliver to the cylinders and combustion chambers, as is commonly known.

The fuel rail arrangement 21 is arranged and configured to receive the fuel from a gaseous fuel tank system 17, as depicted in FIG. 1. As such, the ICE 20 is here configured to receive the pressurized hydrogen gas from the gaseous fuel tank system 17, as illustrated in FIG. 1

As further illustrated in FIG. 1, the gaseous fuel tank system 17 comprises a set of gaseous fuel tanks 17a to 17n. The gaseous fuel tanks 17a to 17n are configured to store pressurized gaseous fuel, such as hydrogen gas fuel 16. For ease of reference, the gaseous fuel tanks may be referred to as fuel tanks, or simply as tanks. Although the pressurized gaseous fuel may be either hydrogen gas or natural gas, the following description will, for ease of reference, refer to the pressurized gaseous fuel as pressurized hydrogen-based gas fuel, pressurized hydrogen gas fuel, or simply as pressurized fuel, or merely as fuel 16. The fuel 16 is considered an integral part of the tanks 17a to 17n, at least in a non-emptied state of a tank.

It can be noted that, in some examples, the vehicle 1 may be a hybrid vehicle, comprising a set of fuel consuming power sources, such as a fuel cell system and the ICE 20.

As illustrated in FIG. 1, the vehicle 1 further comprises a controller 80 configured to control at least some of the operations of the powertrain system 10, as described herein. The controller 80 may be an integral part of a computer system 100. The controller 80 comprises processing circuitry 102 configured to perform the operations, steps, and methods as described in relation to FIGS. 1 to 6.

Turning again to FIG. 1 and the components of the powertrain system 10. As depicted in FIG. 1, the gaseous fuel tank system 17 comprises the set of tanks 17a to 17n.for storing pressurized hydrogen fuel 16. Each one of the tanks 17, 17a to 17n is configured and arranged to store pressurized hydrogen fuel 16. Each one of the fuel tanks 17, 17a to 17n is also configured and arranged to supply fuel 16 to the ICE 20 via a fuel conduit arrangement 30, as illustrated in FIG. 1.

Accordingly, the powertrain system 10 further comprises the fuel conduit arrangement 30. The fuel conduit arrangement 30 is configured to be in fluid communication with the number of tanks 17, 17a to 17n. The fuel conduit arrangement 30 is here also configured to contain and transport fuel 16 from the tanks 17, 17a to 17n to the ICE 20.

More specifically, as illustrated in FIG. 1, the fuel conduit arrangement 30 is configured to be in fluid communication with each one of the fuel tanks of the set of tanks 17, 17a to 17n. Hence, by way of example, the fuel conduit arrangement 30 comprises a fuel conduit 31 extending from a fuel tank 17 to the ICE 20. In this context, the term “fluid communication” refers to transfer of gaseous fluids. Hence, the term “fluid communication” typically refers to a gaseous fluid communication. The term “fluid communication” thus typically means that two components, such as the ICE and the fuel tanks are in gaseous communication with each other.

In FIG. 1, the fuel conduit arrangement 30 comprises a set of fuel conduits, including a first fuel conduit 31 and a second fuel conduit 32. Each one of the fuel conduits 31, 32 is fluidly connected to a corresponding fuel tank 17, such as tank 17a and tank 17b, respectively. Hence, by way of example, as illustrated in FIG. 1, the fuel conduit arrangement 30 comprises the first fuel conduit 31 being fluidly connected to a first fuel tank 17a and the second fuel conduit 32 being fluidly connected to a second fuel tank 17b. It should be noted that the example of FIG. 1 comprises two fuel conduits 31, 32 being configured to fluidly connect the two tanks 17a, 17b to the ICE 20, respectively. However, the number of fuel conduits generally varies in view of the number of tanks 17. As such, each one of the tanks of the powertrain system 10 is configured to be fluidly connected to the ICE 20 by a corresponding fuel conduit. Hence, the powertrain system 10 may comprise any number of tanks 17a to 17c, while the fuel conduit arrangement 30 may comprise any number of fuel conduits.

As such, in FIG. 1, each one of the tanks 17a, 17b is configured to be fluidly connected to the ICE 20 via the fuel conduit arrangement 30 by a corresponding fuel conduit 31, 32. Hence, as illustrated in FIG. 1, the first fuel conduit 31 of the fuel conduit arrangement 30 is fluidly connected to a first fuel tank 17a of the fuel tanks 17, and the second conduit 32 of the fuel conduit arrangement 30 is fluidly connected to a second fuel tank 17b of the fuel tanks 17.

To this end, the fuel conduit arrangement 30 comprises the first fuel conduit 31 and the second fuel conduit 32.

As may also be gleaned from FIG. 1, the tanks 17, 17a to 17b are thus arranged in a parallel configuration. Accordingly, it should also be noted that the tanks 17, 17a to 17n are here arranged in a parallel fuel tank configuration. In this context, a parallel configuration is different to a series configuration of tanks.

Each one of the tanks 17, 17a to 17n may be provided in the form of a large container that stores the vehicle's fuel. Its primary function is to store fuel securely and provide a constant supply to the ICE 20. Each one of the tanks may be located at the rear of the vehicle, underneath the chassis or body, or at any other location on, or in, the vehicle 1. Each one of the tanks 17, 17a to 17n may often comprise additional components such as fuel level sensors, vents, and filler necks for refueling. These types of components are commonly known in the art, and thus not further described herein.

Further, as depicted in FIG. 1, the fuel conduits 31, 32 are here arranged to converge at a common junction point 35 of the fuel conduit arrangement 30.

Also, as depicted in FIG. 1, the fuel conduits 31, 32 are arranged to fluidly connect to the ICE 20 via a common ICE inlet fuel conduit 34. The common ICE inlet fuel conduit 34 is here an integral part of the fuel conduit arrangement 30. However, in other examples, the common ICE inlet fuel conduit 34 may be an integral part of the ICE 20, which is then fluidly connected to the conduit(s) of the fuel conduit arrangement 30.

Accordingly, the fuel conduits 31, 32 are fluidly connected to the common ICE inlet fuel conduit 34.

Turning again to FIG. 1. The powertrain system 10 comprises a compressor assembly 8. The compressor assembly 8 is disposed in the fuel conduit arrangement 30. The compressor assembly 8 is further arranged downstream of at least one of the tanks of the set of tanks 17a to 17n. In FIG. 1 the compressor assembly 8 is arranged downstream of the first fuel tank 17a of the fuel tank system 17.

Accordingly, the compressor assembly 8 is arranged in a gaseous fuel conduit in-between the ICE 20 and the gaseous fuel tank system 17. More specifically, the compressor assembly 8 is arranged in a gaseous fuel conduit in-between the ICE 20 and the gaseous fuel tank system 17, wherein the gaseous fuel conduit here is the first fuel conduit 31 and the gaseous fuel tank system 17 is the first fuel tank 17a. As such, the compressor assembly 8 is arranged in the first fuel conduit 31 and further arranged in-between the ICE 20 and the first fuel tank 17a of the gaseous fuel tank system 17, as depicted in FIG. 1.

As illustrated in FIG. 1, the compressor assembly 8 is here disposed in the first fuel conduit 31. The first fuel conduit 31 is arranged downstream the fuel tank 17a. As illustrated in FIG. 1, the first fuel conduit 31 further comprises a compressor assembly inlet conduit 36 and a compressor assembly outlet conduit 37. The compressor assembly outlet conduit 37 extends between the compressor assembly 8 and the ICE 20. Hence, the compressor assembly outlet conduit 37 is considered as an inlet conduit to the ICE 20, which here intersects with the common ICE inlet fuel conduit 34 at the common junction point 35 of the first and second fuel conduits 31, 32.

In FIG. 1, the compressor assembly 8 is configured to be powered by the ICE 20. As such, the ICE 20 is arranged and configured to operate the compressor assembly 8. Powering the compressor assembly 8 by means of the ICE 20 here involves connecting the ICE 20 to the compressor assembly 8 through a mechanical linkage 22, as illustrated in FIG. 1. In one example, the mechanical linkage comprises a set of rotatable shafts, and one or more joints connecting the shafts to each other. In other examples, the mechanical linkage is provide in the form of a single rotatable shaft.

It is also possible that the compressor assembly 8 can be powered in other ways, such as indirectly by the ICE 20 and/or directly by an auxiliary power source, such as by a generator. For example, the powertrain system 10 may include a hydraulic pump operatively connected to the ICE 20 which through a hydraulic circuit powers the compressor assembly 8. In addition, or alternatively, the powertrain system 10 may include a generator operatively connected to the ICE 20, which generates electricity which powers the compressor assembly 8.

The compressor assembly 8 is further configured to pressurize the gaseous fuel 16 from at least one tank of the fuel tank system 17, which in FIG. 1 is the tank 17a.

Moreover, the powertrain system 10 is operable in a first powertrain operational mode M1, in which gaseous fuel 16 is supplied from at least one of the tanks of the set of tanks 17, 17a to 17n to the ICE 20 in a non-operational mode C1 of the compressor assembly 8.

Also, the powertrain system 10 is operable in a second powertrain operational mode M2, in which gaseous fuel 16 from at least one of the tanks is pressurized by the compressor assembly 8 in an operational mode C2 of the compressor assembly 8, and further supplied to the ICE 20.

As such, the compressor assembly 8 is operable in two different modes, the non-operational mode C1 and the operational mode C2. In the non-operational mode C1, the compressor assembly 8 is not powered by the ICE 20. In the operational mode C2, the compressor assembly 8 is powered by the ICE 20.

The control of the various modes, and the transition between the modes, is performed by the controller 80. Accordingly, as illustrated in FIG. 1, the controller 80 is arranged in communication with the ICE 20, the compressor assembly 8 and the tanks 17a to 17n of the fuel tank assembly 17.

More specifically, as illustrated in FIG. 1, the powertrain system 10 is operable in the first powertrain operational mode M1, in which gaseous fuel 16 is supplied from the second fuel tank 17b of the fuel tank system 17 to ICE 20 when the compressor assembly 8 is in the non-operational mode C1. Accordingly, gaseous fuel 16 is supplied from the fuel tank system 17 directly to the ICE 20.

Typically, in the first powertrain operational mode M1, gaseous fuel 16 is supplied from the first and second fuel tanks 17a and 17b to the ICE 20 via the second fuel conduit 32. Such type of supply of gaseous fuel 16 is possible when the pressure levels of the tanks 17a and 17b are sufficiently high. More specifically, as further described herein, in the first powertrain operational mode M1, gaseous fuel is supplied from the first fuel tank 17a to the ICE 20 via an intermediate fuel conduit 33 and then via the second fuel conduit 32 to the ICE 20, while gaseous fuel 16 is supplied from the second fuel tank 17b via the second fuel conduit 32 to the ICE 20. Such type of supply of gaseous fuel 16 is possible when the pressure levels of the tanks 17a and 17b are sufficiently high. In addition, the compressor assembly 8 is here set in the non-operational mode C1 by the controller 80. As such, in the non-operational mode C1 of the compressor assembly 8, the compressor assembly 8 is by-passed when supplying gaseous fuel 16 to the ICE 20 from the fuel tank system 17.

Also, the powertrain system 10 is operable in the second powertrain operational mode M2, in which gaseous fuel 16 is supplied from the tank 17a (the first fuel tank) and pressurized by the compressor assembly 8 in the operational mode C2 of the compressor assembly 8, and subsequently supplied to the ICE 20. Accordingly, gaseous fuel 16 is supplied from the fuel tank system 17 to the ICE 20 via the compressor assembly 8.

By way of example, in the second powertrain operational mode M2, in which the compressor assembly 8 is in the operational mode C2 (as the pressure level in the first fuel tank 17a is determined to be lower than a needed pressure level for the ICE 20), gaseous fuel 16 is typically supplied from the tanks 17a and 17b to the ICE 20 via the first and second fuel conduits 31, 32, respectively. Such type of supply of gaseous fuel 16 is controlled by the controller 80 when the pressure level of at least the first fuel tank 17a is too low for the ICE 20. More specifically, as further described herein, in the second powertrain operational mode M2, and in the operational mode C2 of the compressor assembly 8, gaseous fuel 16 is supplied from the first fuel tank 17a through the compressor assembly 8, and then supplied to the ICE 20 via the first fuel conduit 31, while gaseous fuel 16 from the second fuel tank 17b can be supplied via the second fuel conduit 32 to the ICE 20.

The compressor assembly 8 can be provided in several different configurations. By way of example, the compressor assembly 8 is a reciprocating compressor having a compressor cylinder for accommodating a compressor piston.

The compressor assembly 8 thus includes a compression chamber or a cylinder in which the working fluid in the form of the fuel 16 is introduced. Inside the chamber, the working fluid (fuel 16) undergoes a compression process. Such process may typically involve the working fluid (fuel 16) being compressed, i.e. the fuel 16 is pressurized.

After the fuel 16 has been pressurized in, and by, the compressor assembly 8, the fuel 16 is directed from the compressor assembly 8 to the ICE 20, and subsequently used as fuel by the ICE 20.

The powertrain system 10 may also include one or more fuel control valves. The fuel control valves may form a fuel control valve arrangement 40. The fuel control valve arrangement 30 here comprises a set of fuel control valves 41, 42.

More specifically, the fuel control valve arrangement 40 is disposed in the fuel conduit arrangement 30. The fuel control valve arrangement 40 comprises a first fuel control valve 41. The first fuel control valve 41 is disposed in the fuel conduit arrangement 30 and in-between the second fuel tank 17b and the ICE 20. The first control valve 41 is configured to regulate a flow of the pressurized fuel 16 from the second fuel tank 17b to the ICE 20.

The first control valve 41 is controlled by the controller 80. Hence, the first control valve 41 is in communication with the controller 80.

In FIG. 1, the first control valve 41 is controlled to prevent fuel 16 to flow from the second fuel tank 17b to the ICE 20 when fuel 16 is supplied from the first fuel tank 17a. In other words, the first control valve 41 is controlled to prevent fuel 16 to flow from the second fuel tank 17b to the ICE 20 when the compressor assembly 8 is in the operational mode C2.

The first fuel control valve 41 can be provided in several different manners. In one example, the first fuel control valve 41 is a pressure regulator valve. In another example, the first fuel control valve 41 is flow block valve. In another example, the first fuel control valve 41 is a flow control valve. Accordingly, the first fuel control valve 41 is provided in the form of a pressure regulator valve, a flow block valve or a flow control valve.

The first fuel control valve 41 should at least be configured to open and close the flow passage of the second fuel conduit 32. Hence, the first fuel control valve 41 is configured to regulate flow of fuel through blocking or stopping the flow of fuel through the fluid conduit 32. Examples of fuel control valves can be shut-off valves or isolation valves used to control the passage of fluid, preventing or allowing flow as needed.

As used herein, a flow control valve is configured to regulate a rate or speed of fuel flow through the flow control valve. As such, a flow control valve is designed to control the volume of fluid passing through it. The flow control valve typically controls flow by adjusting the size of the valve opening or by throttling the flow.

The choice between the valves may generally depend on the specific requirements of the application and the desired control parameters for the fuel being used.

It should thus be appreciated that the term “regulating a flow of pressurized fuel” may refer to a regulation of a fuel flow rate, a regulation of a fuel pressure, and/or a combination of a regulation of fuel flow rate and fuel pressure. The term can thus be interpreted to cover different scenarios, including regulating only the flow rate, only the pressure, or both flow rate and pressure. The flow rate may refer to a regulation of the volumetric flow rate and/or a regulation of the mass flow rate.

In addition, the fuel control valve arrangement 40 comprises a second fuel control valve 42. As illustrated in FIG. 1, the second fuel control valve 42 is disposed in the intermediate fuel conduit 33. The intermediate fuel conduit 33 extends between the first fuel conduit 31 and the second fuel conduit 32. The intermediate fuel conduit 33 is integral part of the fuel conduit arrangement 30.

More specifically, the intermediate fuel conduit 33 extends from a position on the first fuel conduit 31 being located in-between the compressor assembly 8 and the first fuel tank 17a. In other words, the intermediate fuel conduit 33 extends from a position on the first fuel conduit 31 being upstream the compressor assembly 8 and downstream the first fuel tank 17a.

The intermediate fuel conduit 33 is thus arranged to permit flow of fuel 16 between the first fuel conduit 31 and the second fuel conduit 32. More specifically, the intermediate fuel conduit 33 is arranged to permit flow of fuel 16 from the first fuel conduit 31 to the second fuel conduit 32, i.e. from the position of the first fuel conduit 31 being located in-between the compressor assembly 8 and the first fuel tank 17a, and to the second fuel conduit 31.

By the arrangement of the second fuel control valve 42 in the intermediate fuel conduit 33, it becomes possible to regulate a flow of the pressurized fuel 16 in the intermediate fuel conduit 33.

The second fuel control valve 42 is also controlled by the controller 80. Hence, the second fuel control valve 42 is in communication with the controller 80.

In FIG. 1, the second fuel control valve 42 is controlled to allow fuel 16 to flow from the first fuel tank 17a to the second fuel conduit 32, and then to the ICE 20, when the pressure level in the first fuel tank 17a is sufficiently high for meeting the demand from the ICE 20. As such, the second fuel control valve 42 is controlled to allow fuel 16 to flow from the first fuel tank 17a to the second fuel conduit 32, and then to the ICE 20, when the pressure level in the first fuel tank 17a is sufficiently high and when the controller 80 controls the compressor assembly 8 to its non-operational mode C1, and/or when the compressor assembly 8 is in its non-operational mode C1. In the non-operation mode C1 of the compressor assembly 8, no fuel is supplied through the compressor assembly 8.

Moreover, the second fuel control valve 42 is controlled to allow fuel 16 to flow from the second fuel tank 17b to the first fuel conduit 31 when the controller 80 controls the compressor assembly 8 to, and/or in, its operational mode C2.

Moreover, in FIG. 1, the second fuel control valve 42 is controlled to prevent fuel 16 to flow from the second fuel tank 17b to the first fuel conduit 31 when the controller 80 controls the compressor assembly 8 to, and/or in, its operational mode C2.

Accordingly, the ICE 20 can be supplied with fuel 16 from all fuel tanks 17, 17a to 17n, such as fuel tanks 17a and 17b, when the pressure levels of the tanks 17a to 17n are sufficiently high, and when the compressor assembly 8 is in the non-operational mode C1.

The second fuel control valve 42 can be provided in several different manners. In one example, the second fuel control valve 42 is a pressure regulator valve. In another example, the second fuel control valve 42 is flow block valve. In another example, the second fuel control valve 42 is a flow control valve. Accordingly, the second fuel control valve 42 is provided in the form of a pressure regulator valve, a flow block valve or a flow control valve.

The second fuel control valve 42 should at least be configured to open and close the flow passage of the intermediate fuel conduit 33. Hence, the second fuel control valve 42 is configured to regulate flow of fuel through blocking or stopping the flow of fuel through the intermediate fluid conduit 33. Examples of fuel control valves can be shut-off valves or isolation valves used to control the passage of fluid, preventing or allowing flow as needed. The details of the first fuel control valve 41 may be likewise applicable to the second control valve 42.

It should be noted that each one of the conduits 31, 32, 33, 34 etc. making up the fuel conduit arrangement 30 can be provided in the form of a pipe, a line, a hose or the like, which are standard components of a fuel supply system of a vehicle.

The pressure levels of the fuel tanks 17, 17a to 17n are typically measured level. The pressure levels of the fuel tanks 17, 17a to 17n can be measured by a pressure sensor arranged in each one of the fuel tanks. The measured pressure level is transferred to the controller 80 and/or stored in a memory of the controller 80.

Accordingly, in one example, the controller 80 is configured to compare a fuel pressure of the fuel tanks with a demanded fuel pressure level from the ICE 20. The demanded fuel pressure level here corresponds to the predetermined pressure fuel level.

As mentioned herein, the demanded fuel pressure (predetermined pressure fuel level) from the engine 20 may be a demanded fuel rail injection pressure of the 20. Hence, in one example, the controller 80 is configured to compare fuel pressure of the fuel tanks with the demanded fuel rail injection pressure of the engine 20.

In another example, the controller 80 is configured to compare an individual fuel pressure of each one of the fuel tanks with a demanded fuel pressure from the engine 20.

The controller 80 may also be configured to take a demanded fuel flow rate into consideration, the demanded fuel flow rate may either be a fuel volumetric flow rate or a fuel mass flow rate. The controller 80 may for example determine to control the compressor assembly 8 based on pressure level and fuel flow.

The demanded fuel pressure (predetermined pressure fuel level) of the engine 20 can also be determined by the controller 80. The predetermined pressure fuel level may refer to, by way of example, the demanded fuel injection pressure for the engine 20. The predetermined pressure fuel level may also be derivable from data sheets, look-up tables or the like. In addition, or alternatively, the demanded fuel injection pressure for the engine 20 can be determined by the controller 80 by means of receiving operational data from the engine 20.

The controller 80 may also be configured to determine predetermined pressure fuel level based on a pressure map of the engine 20.

In regard to the current fuel pressure of each one of the fuel tanks of the number of fuel tanks, such measurement and/or data is generally received at the controller 80 from one or more sensors arranged in the fuel tanks. Such data may likewise be stored in a memory of the controller 80, and updated during operation of the powertrain system 10.

As mentioned above, the operation of the compressor assembly 8 is controlled by the controller 80. Accordingly, the powertrain system 10 comprises the controller 80, which is in communication with the compressor assembly 8. The controller 80 is configured to control the powertrain system 10 and the operation of the compressor assembly 8.

The controller 80 is configured to control the powertrain system 10 based on predicted changes in relation to the route ahead of the vehicle 1. The controller 80 may be an integral part of a computer system that is configured to control the vehicle 1 based on topography and route data. The controller 80 may comprise, or communicate with, any one of a radar or lidar sensors used to detect vehicles and obstacles ahead, camera system to provide visual data about the road and traffic conditions, and GPS (Global Positioning System) to determine the vehicle position. The controller 80 may further be configured to provide, or acquire, information about the road ahead, including changes in terrain, curves, and upcoming traffic conditions. In some examples, the controller 80 may also acquire information and data about speed and distance settings, brake control data, throttle control to maintain desired speed or accelerate, etc.

In this example, the controller 80 is arranged in communication with a geolocation arrangement 85, such as a GPS receiver or a local positioning arrangement, such as for example a Wi-Fi positioning system. The controller 80 may thus be configured to receive geolocation data via radio or network communication (such as e.g. the Internet) or from any other suitable network communication interface. The controller 80 may also be in communication with a navigation system 84 of the vehicle, which is in communication with the geolocation arrangement 85 (e.g. the GPS receiver).

One example of a navigation system 84 is a predictive cruise control system. Such system typically incorporates the basic functionalities of an automatic cruise control but adds predictive elements. For example, the predictive cruise control system uses GPS and digital maps to anticipate road conditions ahead, such as curves, hills, and changes in the speed limit. Hereby, the predictive cruise control system is configured to adjust the vehicle's speed proactively by considering the upcoming road conditions.

Moreover, the controller 80 is configured to receive route information. Route information can for example be acquired from the navigation system 84 of the vehicle 1. Route information may also be acquired from the remote server or a cloud environment using a wireless connection of the vehicle 1. Furthermore, certain route information may be provided by the driver of the vehicle 1. In addition to data relating to the destination, which is typically determined by the driver, the driver may also provide information describing planned stops along the route. The planned stop may for example be a planned lunch break or other stops.

The controller 80 may also be arranged in communication with a remote server, for example by means of the radio or network communication (such as e.g. the Internet) 85. The remote server is adapted to generate Real Time Traffic Information (RTTI) to be received at the controller 80. The RTTI may for example comprise detailed traffic information in regard to the vicinity of the vehicle, such as the within the next 1000 meters, the next 2000 meters, the next 5000 meters, or less.

Accordingly, the controller 80 is configured to obtain topography data from various sources, such as digital maps, GPS data, or geographic information system (GIS) databases. These sources may generally include relevant information about the road network, including roads, highways, elevation data, and potential destinations. In one example, the topography data is received by the processing circuitry of the controller 80 from the navigation system 84 in the vehicle 1. The topography data may likewise be acquired by a so-called look ahead device, which is typically an integral part of a cruise control system. The look ahead device may in addition, or alternatively, be an integral part of the controller 80, and/or the computer system 100.

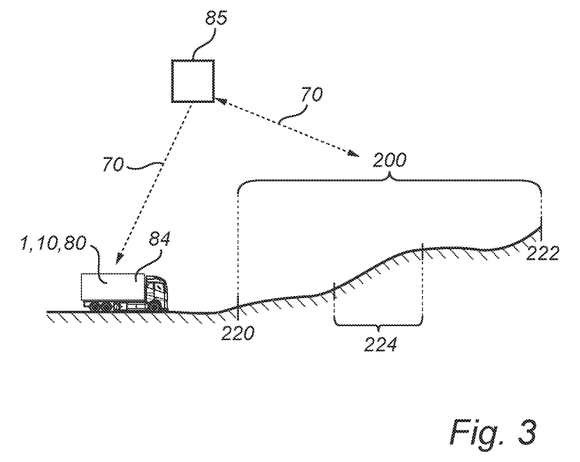

The controller 80 is here configured to predict an expected operational change of the powertrain system 10. More specifically, the controller 80 is configured to predict an expected operational change of the powertrain system 10 based on route information describing at least one route segment for an intended route of the vehicle 1. One example of the configuration of the controller 80 will now be described in relation to FIG. 1 in conjunction with FIG. 3.

FIG. 3 illustrates one example of an intended route 200 for the vehicle 1. As depicted in FIG. 3, the route 200 comprises one or more route segments, such as a route segment 224. Along the route 200, the controller 80 acquires data from the GPS 85 and/or from the navigation system 84.

More specifically, FIG. 3 illustrates an example of controlling the powertrain system 10 of the vehicle 1 of FIG. 1, along a road, i.e. along the intended route 200 for the vehicle 1. FIG. 3 schematically illustrates a heavy-duty vehicle in the form of a loaded truck 10 driving uphill. For ease of reference, an extension of the intended route 200 is here indicated by a number of locations, in which location 220 is a starting position and location 222 is an end position of the route 200. The route 200 here corresponds to the road. The route can be split into different route segments describing different road sections.

The route 200 is in the exemplifying drawings illustrated to comprise at least one separate segment 224, in which there will be a change in the operation of the powertrain system 10 due to an identified change along the route segment, affecting the engine operation.

In FIG. 3, the route segment 224 is indicative of an uphill road segment of the route 200. The route segment 224 is thus a start of a high load condition of the engine 20. That is, in FIG. 3, the change in the route has an impact of the operation of the powertrain system 10, such as change from a low load condition to the high load condition. For completeness, FIG. 3 illustrates the change in altitude as a function of the route distance.

Generally, an increase in altitude along the route (corresponding to an uphill slope) requires an increased engine load, e.g. a need for an increased engine torque. As a consequence, the power demand on the powertrain system 10 will increase in order to provide a sufficient propulsion torque to the wheels during the increased engine load.

In order to permit an early adjustment of the compressor assembly 8 so as to handle the increased power demand in an efficient manner, the controller 80 is configured to gather relevant route information.

The route information is used as a basis for determining the expected operational change of the powertrain system 10 for the upcoming route segment, here corresponding to an upcoming vehicle operating situation. By way of example, before, or at the start position 220, the controller 80 receives an indication of an upcoming change in the vehicle operating situation due to a change of the topography in route segment 224, which in FIG. 3 corresponds to the uphill slope. An upcoming change in the vehicle operating situation caused by driving uphill is likely to affect the operation of the engine 20 to demand more power, thus affecting the engine efficiency. Hence, such increase of the operation of the ICE will result in a demand on the engine to deliver a higher power output during the route segment 224 compared to a previous route segment, e.g. at the start 220 of the route 200.

In this example, the route information comprises the road elevation profile of the route 200, in particular the route elevation profile of the route segment 224. However, the route information typically contains any one of an indication of a speed limit, a road type, a road elevation profile, construction work, and traffic flow. Hence, the controller 80 determines the expected operational change of the powertrain system 10 from route information indicative of any one of the road type of the route segment 224, road elevation profile of the route segment 224, construction work at the route segment 224, and traffic flow in the route segment 224. In one example, the route information comprises all such data, i.e. the route segment 224, road elevation profile of the route segment 224, construction work at the route segment 224, and traffic flow in the route segment 224. As mentioned above, the route information is obtained from topography data, such as GPS data. To this end, the controller 80 is configured to predict changes in operation of the powertrain system 10 and the vehicle 1 from topography data by analyzing and extracting relevant information about the route, including distance, elevation changes, road conditions, and other factors that can affect the vehicle's performance and fuel consumption.

Typically, although strictly not necessary, the controller 80 is configured to obtain route information indicative of the entire intended route for the vehicle 1. Hence, the route information comprises data indicating the starting position 220 and the end position 222 of the route 200 as illustrated by FIG. 3, thereby also giving the travel distance.

By way of example, the controller 80 is configured to predict the expected operational change of the powertrain system 10 by determining any one of an expected operational change in engine load, engine torque, engine revolution and engine acceleration in the route segment 224. More specifically, the controller 80 is configured to predict the expected operational change of the powertrain system 10 in the route segment 224 based on the route information describing the route segment 224, e.g. by predicting any one of an expected operational change in engine load, engine torque, engine revolution and engine acceleration in the route segment 224 based on route information describing the route segment 224.

Furthermore, the controller 80 is configured to determine to control the compressor assembly 8 based on the predicted expected operational change of the powertrain system 10.

The controller 80 can determine to control the compressor assembly 8 based on the predicted expected operational change in several different manners.

In one example, the controller 80 is configured to determine to control the compressor assembly 8 based on the predicted expected operational change of the powertrain system 10 by determining whether to operate the compressor assembly 8 in the operational mode C2, switch from the non-operational mode C1 of the compressor assembly 8 to the operational mode C2 of the compressor assembly 8, remain in the non-operational mode C1 of the compressor assembly 8, or switch from the operational mode C2 of the compressor assembly 8 to the non-operational mode C1 of the compressor assembly 8.

As such, the controller 80 is configured to determine whether to operate in the operational mode C2 of the compressor assembly 8, switch from the non-operational mode C1 of the compressor assembly 8 to the operational mode C2 of the compressor assembly 8, remain in the non-operational mode C1 of the compressor assembly 8, or switch from the operational mode C2 of the compressor assembly 8 to the non-operational mode C1 of the compressor assembly 8 by determining whether operating the compressor assembly 8 will increase or decrease powertrain system efficiency in the one route segment 224.

For example, the controller 80 predicts powertrain system efficiency for the vehicle 1 in the one route segment 224. The powertrain system efficiency typically refers to the engine efficiency. The engine efficiency is determined from an engine efficiency parameter. By way of example, the controller 80 is configured to predict the engine efficiency parameter using the route information describing the route segment 224 for each one of the available first powertrain operational mode M1 (where fuel is supplied from at least one of the tanks to the engine 20 in a non-operational mode of the compressor assembly 8) and the second powertrain operational mode M2 (where fuel from at least one of the tanks is pressurized by the compressor assembly and supplied to the engine 20).

More specifically, the controller 80 predicts a first engine efficiency for operating the powertrain system 10 in the first powertrain operational mode M1 in the route segment 224. Moreover, the controller 80 predicts a second engine efficiency for operating the powertrain system 10 in the second powertrain operational mode M2 in the route segment 224.

The engine efficiency parameter is predicted from the determined expected operational change of the powertrain system 10 due to changes in the topography of the route segment 224. As such, the engine efficiency parameter is predicted from the determined expected operational change in any one of the engine load, engine torque, engine revolution and engine acceleration. While it may be sufficient that only one of the engine load, engine torque, engine revolution and engine acceleration is used for predicting the change, and also the engine efficiency parameter, the controller 80 typically includes a determination of the expected operational change in each one of the engine load, engine torque, engine revolution and engine acceleration.

Subsequently, the controller 80 compares the predicted first engine efficiency with the predicted second engine efficiency.

Then, based on the comparison between the predicted first engine efficiency and the predicted second engine efficiency, the controller 80 determines to operate the powertrain system 10 either in the first powertrain operational mode M1 in the route segment 224 or in the second powertrain operational mode M2 in the route segment 224.

Subsequently, based on the comparison between the predicted first engine efficiency and the predicted second engine efficiency, the controller 80 controls the powertrain system 10 either in the first powertrain operational mode M1 in the route segment 224 or in the second powertrain operational mode M2 in the route segment 224.

Typically, the controller 80 selects the operational mode among the first powertrain operational mode M1 and the second powertrain operational mode M2 that has the determined highest powertrain system efficiency among the predicted first engine efficiency and the predicted second engine efficiency.

To this end, the controller 80 is configured to determine to control the compressor assembly 8 by determining a first powertrain system efficiency, such as the first engine efficiency, for operating the powertrain system 10 in the first powertrain operational mode M1 in the at least one route segment 224 and a second powertrain system efficiency, such as the second engine efficiency, for operating the powertrain system 10 in the second powertrain operational mode M2 in the at least one route segment 224, compare the first powertrain system efficiency with the second powertrain system efficiency, and select the operational mode with the determined highest powertrain system efficiency.

By the above operations of the controller 80, the controller 80 is allowed to predict whether operating the compressor assembly 8 will lead to that the engine 20 operates in a more efficient operating point in the route segment 224 due to the power output from the engine 20 added to operate the compressor assembly 8. If it is predicted that the engine 20 can operate in a more efficient operating point in the route segment 224 by powering the compressor assembly 8 to operate in the operational mode, the controller 80 determines to control the compressor assembly 8 to operate in the operational mode so as to compress gas from the fuel tanks, such as the fuel tank 17a in FIG. 1, which may have a gas pressure below a predetermined threshold, such as 300 bar instead of taking the fuel from a tank, such as the fuel tank 17b that have a pressure higher the than predetermined threshold.

On the other hand, if the controller 80 predicts that the efficiency of the engine 20 will decrease in the route segment 224, the compressor assembly 8 is controlled to, or in, the non-operational mode. In other words, the controller 80 determines that the compressor assembly 8 should not be run and the fuel should instead be taken directly from the tank, such as the tank 17b, that has sufficiently high gas pressure. In this manner, the overall efficiency of the powertrain system 10 may be increased in route segment 224 which will provide a longer range of the vehicle 1. It should be noted that the controller 80 is typically configured to control the compressor assembly 8 during operating conditions of the tanks 17, 17a to 17n, where there is at least one tank with low gas pressure and at least one tank with high enough gas pressure.

Hereby, there is provided a more dynamic and precise regulation of the fuel 16 from the fuel tanks 17, 17a to 17n to the engine 20, which is based on route information to predict changes in the operating conditions of the powertrain system 10. By the above operations of the controller 80, the controller 80 is configured to predict if the engine efficiency is increased by running the compressor assembly 8 in the route segment 224. In that case, the controller 80 determines to operate the compressor assembly 8 with fuel from the fuel tank with low pressure instead of taking gas from a fuel tank with high pressure. In addition, or alternatively, the controller 80 is configured to predict if the engine efficiency is decreased by operating the compressor assembly 8 in the route segment 224. In that case, the controller 80 determines not to operate the compressor assembly 8, while controlling the powertrain system 10 to direct fuel from a tank with high pressure to the engine 20 in the route segment 224.

Determining whether operating the compressor assembly 8 will increase or decrease powertrain system efficiency in the one route segment 224 can be performed in several different manners by the controller 80. In one example, the controller 80 compares the predicted first engine efficiency and the predicted second engine efficiency, and decides to control the compressor assembly 8 based on the most favorable engine efficiency level resulting from the predicted first engine efficiency and the predicted second engine efficiency. By way of example, if the predicted second engine efficiency is higher than the predicted first engine efficiency, the controller 80 is configured to control the compressor assembly 8 in the operational mode C2, such that the compressor assembly 8 can pressurize gaseous fuel 16 to the predetermined pressure fuel level. On the other hand, if the predicted first engine efficiency is equal to, or higher than, the predicted second engine efficiency, the controller 80 is configured to control the compressor assembly 8 in the non-operational mode C1, allowing gaseous fuel 16 from at least one of the gaseous fuel tanks of the set of gaseous fuel tanks 17, 17a to 17n to be supplied to the engine 20.

In FIG. 1, the fuel 16 is thus supplied from both the first fuel tank 17a and the second fuel tank 17b to the engine 20, i.e. when the compressor assembly 8 in the non-operational mode C1 and the predicted first engine efficiency is equal to, or higher than, the predicted second engine efficiency.

To sum up, the controller 80 is thus configured to operate the compressor assembly in the operational mode to pressurize fuel from one or more fuel tanks if the predicted second engine efficiency is higher than the predicted first engine efficiency, and to operate the compressor assembly in the non-operational mode if the predicted first engine efficiency is equal or higher than the predicted second engine efficiency.

It should also be noted that determining whether operating the compressor assembly 8 will increase or decrease powertrain system efficiency in the one route segment 224 may comprise other parameters for determining the powertrain system efficiency when operating the compressor assembly 8 in the non-operational mode C1 in the route segment 224 and for determining the powertrain system efficiency when operating the compressor assembly 8 in the operational mode C2 in the route segment 224.

For example, the controller 80 is also configured to predict the compressor assembly power demand for the route segment 224 of the route 200 ahead of the vehicle 1. The power demand of the compressor assembly 8 is determined for an operating situation using the compressor assembly 8 in the second powertrain operational mode M2. Typically, the compressor assembly power demand is included in determining the second engine efficiency for operating the powertrain system 10 in the second powertrain operational mode M2 in the route segment 224.

Accordingly, the compressor assembly 8 may be operable in the route segment 224 to increase the pressure of the fuel from the tank(s). The compressor assembly power demand here means the needed power for operating the compressor assembly 8 to increase the pressure of the fuel from the fuel tank(s) to a sufficient level for the engine 20 so as to allow the engine 20 to provide the necessary power in the route segment 224. The sufficient level of the fuel pressure level can be derived from a look-up table. The level can also be a predetermined level.

As such, in one extended example, the controller 80 is further configured to determine an powertrain efficiency parameter for the first powertrain operational mode M1 based on data indicative of pressure levels of each one of the gaseous fuel tanks 17a to 17n, and determine a corresponding powertrain efficiency parameter for the second powertrain operational mode M2 based on data indicative of pressure levels of each one of the gaseous fuel tanks 17a to 17n and a needed power output from the engine 20 for operating the compressor assembly 8 to provide a predetermined pressure fuel level.

In one example, the controller 80 is configured to predict the engine efficiency parameter for operating the for the second powertrain operational mode M2 in the route segment 224 from route information, received data indicative of at least one pressure level of at least one gaseous fuel tank of the set of gaseous fuel tanks, and a needed power output from the engine 20 for operating the compressor assembly 8 to provide a predetermined pressure fuel level. The needed power output from the engine 20 is e.g. derived from data indicative of the pressure in the low-pressure tank, such as the pressure of the fuel tank 17a and data indicative of the efficiency of the engine 20 (i.e. the current efficiency parameter).

Moreover, the predetermined pressure fuel level may be determined based on the estimated demand from the engine 20 in the route segment 224. As example, the predetermined pressure fuel level may be about 350 bar for an engine, such as a high-pressure direct injection ICE operable on hydrogen gas. However, the predetermined pressure fuel level may vary for different ICEs and different powertrain systems.

In an extended example, the controller 80 is here also configured to determine a current powertrain system efficiency and determine to control the compressor assembly 8 based on a comparison with the determined current powertrain system efficiency.

The current powertrain system efficiency typically refers to the current engine efficiency. The current engine efficiency is determined from a current engine efficiency parameter. By way of example, the controller 80 is configured to receive data indicative of a current engine efficiency parameter. Alternatively, or in addition, the controller 80 is configured to receive data indicative of current engine torque and current engine speed, and further configured to determine the current engine efficiency parameter based on the current engine torque and current engine speed. Moreover, in this example, the controller 80 is here configured to receive data indicative of pressure levels in one or more tanks of the set of tanks. Typically, the controller 80 is configured to receive data of pressure levels of all gaseous tanks of the set of tanks 17a to 17n.

Based on the received, or determined current engine efficiency parameter and received data indicative of at least one pressure level of at least one tank of the set of tanks, the controller 80 predicts a first expected change in the engine efficiency for the first powertrain operational mode M1 by comparing the current engine efficiency parameter with the predicted engine efficiency parameter for the engine at the route segment 224.

Moreover, the first powertrain system efficiency and the second powertrain system efficiency are typically each individually compared with the determined current powertrain system efficiency.

Depending on the current operational mode of the powertrain system 10, the current powertrain system efficiency is either the powertrain system efficiency for the first powertrain operational mode M1 or the powertrain system efficiency of the second powertrain operational mode M2.

In one example, the controller 80 is configured to compare the predicted expected operational change of the powertrain system 10 with a threshold value. For example, the controller 80 is configured to compare the predicted expected operational change of the powertrain system 10 with a threshold value by predicting an expected change in the powertrain system efficiency in the route segment 224, and compare the predicted expected change in the powertrain system efficiency with a threshold value indicative to an acceptable powertrain system efficiency for the powertrain system 10. Then, if the predicted expected change in the powertrain system efficiency meets, or exceeds, the threshold value, the controller 80 determines to control the compressor assembly 8 based on the predicted expected operational change of the powertrain system 10. Such control can include e.g. a switch from the first powertrain operational mode M1 to the second powertrain operational mode M2, or a switch from the second powertrain operational mode M2 to the first powertrain operational mode M1.

The threshold value is typically stored in the controller 80. For example, the threshold value is a predetermined value of an acceptable powertrain system efficiency.

In one example, the controller 80 is further configured to predict the expected operational change of the powertrain system 10 based on a previous powertrain system operating profile for the route segment 224. The previous powertrain system operating profile for the route segment 224 may be based on previous vehicle operating cycle statistics. The previous powertrain system operating profile for the route segment 224 can be based on previous vehicle operating cycle statistics for the same vehicle or for a different previous vehicle.

Moreover, in some examples, the predictive information is generated based on historical route data for the intended route for the vehicle 1.

The controller 80 may typically also be configured to determine a duration of the vehicle 1 in the route segment 224 based on the route information and available vehicle data, such as vehicle speed etc. The duration of the vehicle in route segment 224 is e.g. determined by the navigation system 84, as is commonly known in the art.

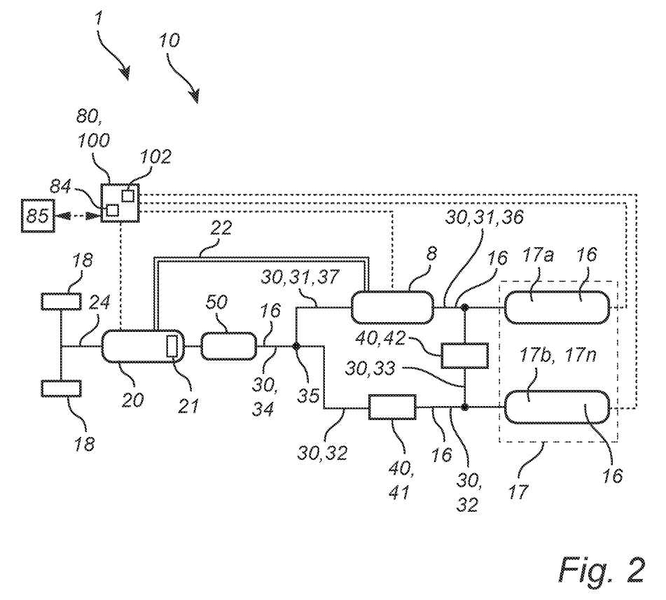

FIG. 2 schematically illustrates another exemplary vehicle comprising a powertrain system. The powertrain system 10, vehicle 1 and the controller 80 of FIG. 2 here comprise the features, examples and components as described above in relation to the powertrain system 10, vehicle 1 and the controller 80 of FIG. 1. In addition, in FIG. 2, the powertrain system 10 comprises a buffer tank 50. The buffer tank 50 is arranged between the engine 20 and the gaseous fuel tanks 17a to 17n. Moreover, the buffer tank 50 is configured to store fuel 16 compressed by the compressor assembly 8. More specifically, the buffer tank 50 is configured to store fuel 16 compressed by the compressor assembly 8 for use during conditions when operating the compressor assembly 8 is predicted to decrease engine efficiency. The buffer tank 50 is here of a similar type as the other fuel tanks 17a to 17n. However, the buffer tank 50 comprises an inlet for receiving fuel from the fuel tanks 17a to 17n and an outlet for discharging fuel to the engine 20. The buffer tank 50 is arranged to receive fuel 16 directly from the fuel tanks, such as from the fuel tank 17b, and/or indirectly from the fuel tanks via the compressor assembly 8, e.g. indirectly from the fuel tank 17a via the compressor assembly 8.

In FIG. 2, when the powertrain system 10 comprises the buffer tank 50, the controller 80 is typically configured to prioritize the operation of the compressor assembly 8 when the predicted expected operational change of the powertrain system 10 is indicative of engine load conditions favoring increased efficiency from pressurized fuel supply. More specifically, the controller 80 prioritizes the operation of the compressor assembly 8 when predictive information indicates that engine load conditions favor increased efficiency from pressurized fuel supply. In addition, the controller 80 typically conserves pressurized fuel in the gaseous fuel tanks for use during high engine power demands where the compressor assembly operation is less efficient. Such configuration here typically includes predicting the powertrain efficiency in the route segment 224 when operating the compressor assembly 8, as determined above, and compare the predicted powertrain efficiency with a reference threshold value. The reference threshold value can be a predetermined value indicative of an acceptable powertrain efficiency, such as the acceptable engine efficiency.

Moreover, in FIG. 2, the controller 80 is configured to control the use of the buffer tank 50 by filling the buffer tank 50 with excess pressurized fuel produced by the compressor assembly 8 during periods predicted to have low engine fuel consumption, and to utilize the stored pressurized fuel during periods when operating the compressor assembly 8 is predicted to decrease powertrain system efficiency.

In addition, in FIG. 2, the controller 80 is configured to deplete the buffer tank 50 prior to an anticipated engine braking event, and further configured to operate the compressor assembly 8 during the engine braking to refill the buffer tank 50 without consuming additional fuel. The engine braking event is here anticipated based on the predictive information, such as the topography data. One example of an engine braking event is a downhill descent.

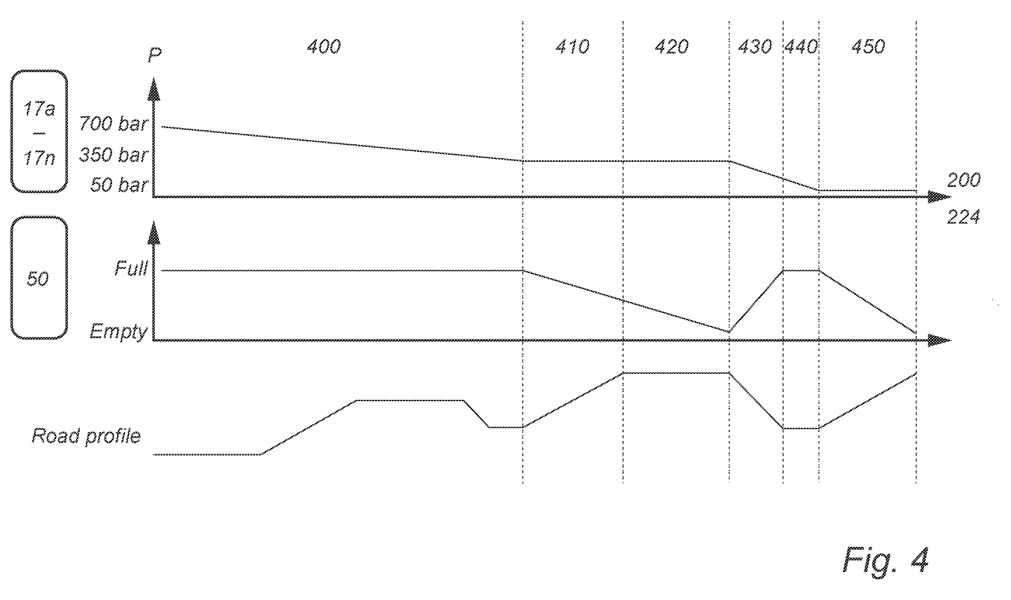

The control and use of the buffer tank 50 in combination with the control and use of the compressor assembly 8 will now be further described in relation to FIG. 4. FIG. 4 illustrates a sequence of operations of the vehicle 1 and the powertrain system 10 for a route comprising one or more route segments with a varying road profile. More specifically, FIG. 4 shows the pressure levels in tanks 17a to 17n along the intended route 200. As mentioned herein, the controller 80 continuously receives route information during the operation of vehicle 1 along the route 200. Furthermore, the controller 80 predicts expected operational changes of the powertrain system 10 based on the route information, describing at least one route segment 224 of the route 200. Based on the predicted changes in the operation of the powertrain system 10, the controller 80 determines how to control the compressor assembly 8 along the route 200 and through route segment 224.

Additionally, when the powertrain system 10 includes the buffer tank 50, as illustrated in FIG. 2, the controller 80 can determine how to control both the compressor assembly 8 and the buffer tank 50 according to the following operations. For example, as shown in a sub-segment 400 of the route segment 224, the controller 80 operates the powertrain system 10 in the first powertrain operational mode M1, where fuel 16 is supplied directly from the tanks 17a to 17n to the engine 20, while the compressor assembly 8 remains in the non-operational mode. In the sub-segment 400 operation, the buffer tank 50 functions as an intermediate step for transferring fuel 16 to the engine 20. Fuel 16 is drawn from tanks 17a to 17n until the fuel pressure level in the tanks falls below a certain pressure level, such as a pressure level of 350 bar.

Next, in a sub-segment 410 of the route segment 224, as illustrated in FIG. 4, the controller 80 predicts an upcoming uphill segment in a subsequent sub-segment 410, which will affect the operation of the powertrain system 10. Consequently, the controller 80 predicts changes in the operation of the powertrain system 10 based on route information, such as the route profile data. In sub-segment 410, the controller 80 also determines to empty the buffer tank 50 to avoid using the compressor assembly 8 during the uphill segment. Therefore, the controller 80 keeps the powertrain system 10 in the first powertrain operational mode M1 (i.e., with the compressor assembly 8 in the non-operational mode), while controlling the buffer tank 50 to deplete its fuel. The reasoning behind such control strategy is to minimize, or at least reduce, compressor losses and cooling demands. Additionally, the controller 80 evaluates engine efficiency and predicts a decrease in efficiency during sub-segment 410 if the compressor assembly 8 were to be engaged, which is inferred from the route profile of the route segment 224.

In sub-segment 420 of route segment 224, as shown in FIG. 4, the controller 80 predicts that a downhill segment will immediately follow (i.e. in sub-segment 430). As a result, the controller 80 predicts further changes in the operation of the powertrain system 10 based on route profile data. With the downhill segment identified in sub-segment 430, the controller 80 determines that the powertrain system 10 should remain in the first powertrain operational mode M1 (i.e., with the compressor assembly 8 still in non-operational mode), while continuing to deplete the buffer tank 50, as the vehicle 1 is approaching the downhill segment in sub-segment 430.

Once the vehicle 1 reaches the sub-segment 430, the controller 80 determines to switch from the non-operational mode C1 of the compressor assembly 8 to the operational mode C2 of the compressor assembly 8 and controls the compressor assembly 8 to operate at full capacity to pressurize the buffer tank 50. During the downhill operation, the compressor assembly 8 can be operated without additional energy expenditure. In other words, the controller 80 shifts the powertrain system 10 from the first operational mode M1 to the second operational mode M2, responding to the predicted change (based on route information) from operating on a flat section (sub-segment 420) to a downhill segment (sub-segment 430), thereby controlling the compressor assembly 8 based on the predicted operational change in the powertrain system 10.

Subsequent, when the vehicle 1 is in sub-segment 440, the controller 80 determines to operate the compressor assembly 8 at an intermediate load to maintain the pressure level in the buffer tank 50 due to predicted uphill segment in the subsequent sub-segment 450. Moreover, the controller 80 here typically also determines the engine efficiency and that the engine efficiency will slightly increase in the sub-segment 440 by running the compressor assembly 8, which can be predicted from the route profile of the sub-segments in 430 and 440.

Subsequently, in sub-segment 440, the controller 80 determines that the compressor assembly 8 should operate at an intermediate load to maintain the pressure level in the buffer tank 50, due to the predicted uphill segment in the following sub-segment 450. Furthermore, the controller 80 typically evaluates engine efficiency and predicts a slight increase in efficiency during sub-segment 440 by operating the compressor assembly 8, as inferred from the route profiles of sub-segments 430 and 440.

Finally, in sub-segment 450, the controller 80 again predicts an upcoming uphill segment, which will affect the operation of the powertrain system 10. Consequently, the controller 80 predicts changes in the operation of the powertrain system 10 based on route information, such as the route profile data. In sub-segment 450, the controller 80 also determines to empty the buffer tank 50 to avoid using the compressor assembly 8 during the uphill segment. Therefore, the controller 80 controls the powertrain system 10 in the first powertrain operational mode M1 (i.e., with the compressor assembly 8 in the non-operational mode), while controlling the buffer tank 50 to deplete its fuel. The reasoning behind such control strategy is to minimize, or at least reduce, compressor losses and cooling demands. Additionally, the controller 80 evaluates engine efficiency and predicts a decrease in efficiency during sub-segment 450 if the compressor assembly 8 were to be engaged, which is inferred from the route profile of sub-segment 450.

To this end, as exemplified by the example in FIG. 4, the controller 80 controls the use of compressor assembly 8 and the buffer tank 50 by filling the buffer tank 50 with excess pressurized fuel produced by the compressor assembly 8 during periods predicted to have low engine fuel consumption, and to utilize the stored pressurized fuel during periods when operating the compressor assembly 8 is predicted to decrease powertrain system efficiency.

To sum up, by having prior knowledge of the road profile, allowing for predicting expected operational changes such as engine speed and torque, it is possible to improve the operation of the compressor assembly 8 to reduce fuel consumption. For example, if the route is known to end within a distance where the fuel pressure in the tanks 17a to 17n will remain sufficiently high throughout the journey, and refueling is available at the destination, the compressor assembly 8 may not need to be activated at all. Moreover, when it is possible to predict engine operation at load levels where running the compressor assembly 8 will enhance engine efficiency, the compressor assembly 8 can be prioritized for operation during such intervals. Such approach allows conserving high-pressure fuel tanks for route segments of the route where running the compressor assembly 8 would decrease engine efficiency (typically at higher engine power outputs). In addition, or alternatively, if a buffer tank 50 of sufficient capacity is available, as described in the system of FIGS. 2 and 4, it can be utilized to store fuel compressed by the compressor assembly 8. The compressor assembly 8 could be run at a higher load than the engine’s immediate requirements, thereby increasing fuel flow and storing excess fuel in the buffer tank 50. The stored fuel can then be used when operating the compressor assembly 8 would be less favorable for engine efficiency. Moreover, if it is known that a downhill segment, where engine braking will occur, is approaching, the buffer tank 50 can be depleted before the descent. During the downhill segment, the compressor assembly 8 can be operated to refill the buffer tank 50 without consuming any additional fuel.

Overall, the proposed powertrain system 10 improves the efficiency and range of the vehicle 1 by minimizing, or at least reducing, the fuel 16 used to power the compressor assembly 8.

It should be noted that data indicative of the engine efficiency parameter may be received by the controller 80. Alternatively, or in addition, the engine efficiency parameter is determined by the controller 80 from received data indicative of predicted and/or current engine torque and engine speed. Determining engine efficiency from engine torque and engine speed belongs to common general knowledge within the field of engines, and thus not further described.

Throughout the disclosure, it should be noted that the current engine torque and current engine speed can be monitored by one or more sensors as is commonly known in the art, and/or be monitored by an engine control unit, and then transferred to the controller 80. By way of example, the engine speed is monitored by a sensor, such as a speed sensor, while the engine torque is calculated by the controller 80 from received input data from one or more engine sensors in combination with a gas pedal position configured to measure the position of the gas pedal. In some examples, the computer system 100 may include both the engine control unit and the controller 80 of the powertrain system 10. In other examples, the control 80 may at least partly include the engine control unit.

The controller 80 may also be configured to determine pressure levels of each individual fuel tank 17a to 17n of the fuel tank system 17, and control the compressor assembly 8 based on pressure levels of each individual fuel tank of the fuel tank system 17.

It should be noted that the above presentation of the powertrain system 10 should also be regarded as disclosing a method for controlling the powertrain system 10, for instance using the controller 80 and the processing circuitry 102.

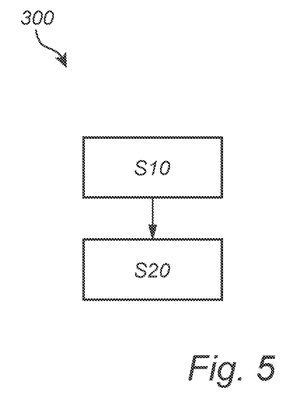

FIG. 5 is a flow chart of an exemplary method to control the powertrain system 10 of the vehicle 1 according to an example. More specifically, FIG. 5 is an exemplary computer implemented method 300 according to an example. The computer-implemented method 300 is intended for controlling for controlling the compressor assembly 8 of the powertrain system 10 for the vehicle 1. The method 300 is implemented by the controller 80 having the processing circuitry 102.

As mentioned herein, the powertrain system 10 is operable in the first powertrain operational mode M1, in which gaseous fuel 16 is supplied from at least one of the gaseous fuel tanks 17b of the set of gaseous fuel tanks 17a to 17n to the engine 20 in the non-operational mode of the compressor assembly 8, and in the second powertrain operational mode M2, in which gaseous fuel 16 from at least one of the gaseous fuel tanks 17a is pressurized by the compressor assembly 8 in the operational mode of the compressor assembly 8, and subsequently supplied to the ICE 20.

As illustrated in FIG. 5, the method 300 comprises a step S10 of predicting, by processing circuitry 102 of the controller 80, an expected operational change of the powertrain system 10 based on route information describing at least one route segment 224 for an intended route of the vehicle 1. The processing circuitry 102 is configured to implement this step.

Next, the method 300 comprises a step S20 of determining, by the processing circuitry 102 of the controller 80, to control the compressor assembly 8 based on the predicted expected operational change. The processing circuitry 102 is configured to implement this step.

In one examples, the step S20 of determining to control the compressor assembly 8 based on the predicted expected operational change of the powertrain system 10 comprises determining whether to operate in the operational mode C2, switch from the non-operational mode C1 to the operational mode C2, remain in the non-operational mode C1, or switch from the operational mode C2 to the non-operational mode C1.

The method 300 may also comprise controlling any one of the fuel control valves, as described herein.

In some examples, there is provided a computer program product comprising program code for performing, when executed by the processing circuitry 102, the method 300 as described above.

In some examples, there is provided a non-transitory computer-readable storage medium comprising instructions, which when executed by the processing circuitry 102, cause the processing circuitry 102 to perform the method 300 as described above.

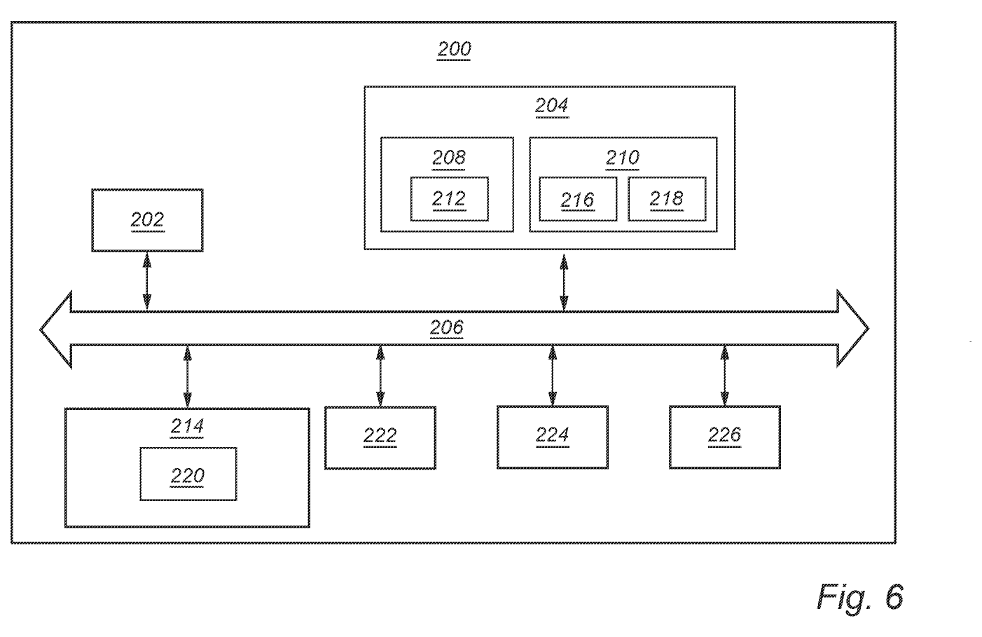

Further details of one example of a computer system that can be used as the controller 80 will now be described in relation to FIG. 6. The controller 80 can be an integral part of the computer system. In some examples, the controller 80 is the computer system. In some examples, the controller 80 may comprise a number of sub-controllers (not shown), wherein a first sub-controller is configured to control the compressor assembly 8, a second sub-controller is configured to control the engine 20, and a third sub-controller is configured to control the fuel tanks 17. In addition, the sub-controllers are configured to communicate with each other.

FIG. 6 is a schematic diagram of a computer system 200 for implementing examples disclosed herein. The computer system 200 is adapted to execute instructions from a computer-readable medium to perform these and/or any of the functions or processing described herein. The computer system 200 may be connected (e.g., networked) to other machines in a LAN (Local Area Network), LIN (Local Interconnect Network), automotive network communication protocol (e.g., FlexRay), an intranet, an extranet, or the Internet. While only a single device is illustrated, the computer system 200 may include any collection of devices that individually or jointly execute a set (or multiple sets) of instructions to perform any one or more of the methodologies discussed herein. Accordingly, any reference in the disclosure and/or claims to a computer system, computing system, computer device, computing device, control system, control unit, electronic control unit (ECU), processor device, processing circuitry, etc., includes reference to one or more such devices to individually or jointly execute a set (or multiple sets) of instructions to perform any one or more of the methodologies discussed herein. For example, control system may include a single control unit or a plurality of control units connected or otherwise communicatively coupled to each other, such that any performed function may be distributed between the control units as desired. Further, such devices may communicate with each other or other devices by various system architectures, such as directly or via a Controller Area Network (CAN) bus, etc.

The computer system 200 may comprise at least one computing device or electronic device capable of including firmware, hardware, and/or executing software instructions to implement the functionality described herein. The computer system 200 may include processing circuitry 202 (e.g., processing circuitry including one or more processor devices or control units), a memory 204, and a system bus 206. The computer system 200 may include at least one computing device having the processing circuitry 202. The system bus 206 provides an interface for system components including, but not limited to, the memory 204 and the processing circuitry 202. The processing circuitry 202 may include any number of hardware components for conducting data or signal processing or for executing computer code stored in memory 204. The processing circuitry 202 may, for example, include a general-purpose processor, an application specific processor, a Digital Signal Processor (DSP), an Application Specific Integrated Circuit (ASIC), a Field Programmable Gate Array (FPGA), a circuit containing processing components, a group of distributed processing components, a group of distributed computers configured for processing, or other programmable logic device, discrete gate or transistor logic, discrete hardware components, or any combination thereof designed to perform the functions described herein. The processing circuitry 202 may further include computer executable code that controls operation of the programmable device.

The system bus 206 may be any of several types of bus structures that may further interconnect to a memory bus (with or without a memory controller), a peripheral bus, and/or a local bus using any of a variety of bus architectures. The memory 204 may be one or more devices for storing data and/or computer code for completing or facilitating methods described herein. The memory 204 may include database components, object code components, script components, or other types of information structure for supporting the various activities herein. Any distributed or local memory device may be utilized with the systems and methods of this description. The memory 204 may be communicably connected to the processing circuitry 202 (e.g., via a circuit or any other wired, wireless, or network connection) and may include computer code for executing one or more processes described herein. The memory 204 may include non-volatile memory 208 (e.g., read-only memory (ROM), erasable programmable read-only memory (EPROM), electrically erasable programmable read-only memory (EEPROM), etc.), and volatile memory 210 (e.g., random-access memory (RAM)), or any other medium which can be used to carry or store desired program code in the form of machine-executable instructions or data structures and which can be accessed by a computer or other machine with processing circuitry 202. A basic input/output system (BIOS) 212 may be stored in the non-volatile memory 208 and can include the basic routines that help to transfer information between elements within the computer system 200.

The computer system 200 may further include or be coupled to a non-transitory computer-readable storage medium such as the storage device 214, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 214 and other drives associated with computer-readable media and computer-usable media may provide non-volatile storage of data, data structures, computer-executable instructions, and the like.

Computer-code which is hard or soft coded may be provided in the form of one or more modules. The module(s) can be implemented as software and/or hard-coded in circuitry to implement the functionality described herein in whole or in part. The modules may be stored in the storage device 214 and/or in the volatile memory 210, which may include an operating system 216 and/or one or more program modules 218. All or a portion of the examples disclosed herein may be implemented as a computer program 220 stored on a transitory or non-transitory computer-usable or computer-readable storage medium (e.g., single medium or multiple media), such as the storage device 214, which includes complex programming instructions (e.g., complex computer-readable program code) to cause the processing circuitry 202 to carry out actions described herein. Thus, the computer-readable program code of the computer program 220 can comprise software instructions for implementing the functionality of the examples described herein when executed by the processing circuitry 202. In some examples, the storage device 214 may be a computer program product (e.g., readable storage medium) storing the computer program 220 thereon, where at least a portion of a computer program 220 may be loadable (e.g., into a processor) for implementing the functionality of the examples described herein when executed by the processing circuitry 202. The processing circuitry 202 may serve as a controller or control system for the computer system 200 that is to implement the functionality described herein.

The computer system 200 may include an input device interface 222 configured to receive input and selections to be communicated to the computer system 200 when executing instructions, such as from a keyboard, mouse, touch-sensitive surface, etc. Such input devices may be connected to the processing circuitry 202 through the input device interface 222 coupled to the system bus 206 but can be connected through other interfaces, such as a parallel port, an Institute of Electrical and Electronic Engineers (IEEE) 1394 serial port, a Universal Serial Bus (USB) port, an IR interface, and the like. The computer system 200 may include an output device interface 224 configured to forward output, such as to a display, a video display unit (e.g., a liquid crystal display (LCD) or a cathode ray tube (CRT)). The computer system 200 may include a communications interface 226 suitable for communicating with a network as appropriate or desired.

The operational actions described in any of the exemplary aspects herein are described to provide examples and discussion. The actions may be performed by hardware components, may be embodied in machine-executable instructions to cause a processor to perform the actions, or may be performed by a combination of hardware and software. Although a specific order of method actions may be shown or described, the order of the actions may differ. In addition, two or more actions may be performed concurrently or with partial concurrence.

Moreover, the present disclosure may be exemplified by any one of the below examples.

Example 1. A powertrain system 10 for a vehicle 1, the powertrain system comprising: an internal combustion engine 20 operable on a gaseous fuel; a gaseous fuel tank system 17 having a set of gaseous fuel tanks 17a to 17n for storing pressurized gaseous fuel, the gaseous fuel tank system being configured to be in fluid communication with the engine; and a compressor assembly 8 for pressurizing gaseous fuel, wherein the powertrain system is operable in a first powertrain operational mode where gaseous fuel is supplied from at least one of the gaseous fuel tanks to the engine in a non-operational mode of the compressor assembly, and in a second powertrain operational mode where gaseous fuel from at least one of the gaseous fuel tanks is pressurized by the compressor assembly in an operational mode of the compressor assembly and supplied to the engine; wherein the powertrain system further comprises a controller 80 configured to: predict an expected operational of the powertrain system based on route information describing at least one route segment 224 for an intended route of the vehicle; and, determine to control the compressor assembly based on the predicted expected operational change of the powertrain system.

Example 2. Powertrain system according to example 1, wherein determine to control the compressor assembly based on the predicted expected operational change of the powertrain system comprises determining whether to operate the compressor assembly in the operational mode, switch from the non-operational mode to the operational mode, remain in the non-operational mode, or switch from the operational mode to the non-operational mode.

Example 3. Powertrain system according to example 2, wherein the controller is configured to determine whether to operate the compressor assembly in the operational mode, switch from the non-operational mode to the operational mode, remain in the non-operational mode, or switch from the operational mode to the non-operational mode by determining whether operating the compressor assembly will increase or decrease powertrain system efficiency in the at least one route segment.

Example 4. The powertrain system of any previous examples, wherein the controller is configured to determine to control the compressor assembly by determining a first powertrain system efficiency for operating the powertrain system in the first powertrain operational mode in the at least one route segment and a second powertrain system efficiency for operating the powertrain system in the second powertrain operational mode in the at least one route segment, compare the first powertrain system efficiency and the second powertrain system efficiency, and select the operational mode with the determined highest powertrain system efficiency.

Example 5. The powertrain system of any previous examples, wherein the route information contains any one of an indication of a speed limit, a road type, a road elevation profile, construction work, and traffic flow.

Example 6. The powertrain system of any previous examples, wherein the controller is further configured to predict the expected operational change of the powertrain system based on a previous powertrain system operating profile for the route segment.

Example 7. The powertrain system of any previous examples, wherein the controller is further configured to obtain route information indicative of an intended route for the vehicle.

Example 8. The powertrain system of any previous examples, wherein the controller is further configured to determine a current powertrain system efficiency and determine to control the compressor assembly based on a comparison with the determined current powertrain system efficiency.

Example 9. The powertrain system of any previous examples, wherein the controller is configured to predict the expected operational change of the powertrain system by determining any one of an expected change in engine load, engine torque, engine revolution and engine acceleration in the at least one route segment.

Example 10. The powertrain system of any previous examples, wherein the predictive information is generated based on historical route data for the intended route for the vehicle.

Example 11. The powertrain system of any previous examples, wherein the controller is further configured to prioritize the operation of the compressor assembly when the predicted expected operational change of the powertrain system is indicative of engine load conditions favoring increased efficiency from pressurized fuel supply.

Example 12. The powertrain system of any previous examples, further comprising a buffer tank 50 arranged between the engine and the gaseous fuel tanks, wherein the buffer tank stores fuel compressed by the compressor assembly for use during conditions where operating the compressor assembly is predicted to decrease engine efficiency.

Example 13. The powertrain system of example 12, wherein the controller is configured to control the use of the buffer tank by filling it with excess pressurized fuel produced by the compressor assembly during periods predicted to have low engine fuel consumption, and to utilize the stored pressurized fuel during periods where operating the compressor assembly is predicted to decrease powertrain system efficiency.

Example 14. The powertrain system of examples 12 to 13, wherein the controller is configured to deplete the buffer tank prior to an anticipated engine braking event, and to operate the compressor assembly during the engine braking to refill the buffer tank without consuming additional fuel.

Example 15. The powertrain system of any previous examples, wherein the gaseous fuel is either a hydrogen-based fuel or a natural gas fuel.

Example 16. The powertrain system of any previous examples, wherein the compressor assembly is configured to at least partly be powered by the internal combustion engine, and/or wherein the compressor assembly is configured to at least partly be powered by an auxiliary power source.

Example 17. The powertrain system of any previous examples, wherein the controller is configured to predict the compressor assembly power demand for the at least one road segment of the route ahead of the vehicle.

Example 18. The powertrain system of any previous examples, wherein the controller is further configured to control the operation of the compressor assembly.

Example 19. The powertrain system of any previous examples, wherein the route information is obtained from topography data, such as GPS data.

Example 20. A vehicle comprising a powertrain system according to any one of examples 1 to 19.

Example 21. A method for controlling a compressor assembly of a powertrain system 10 for a vehicle 1, wherein the method comprises: predicting S10, by processing circuitry of a controller, an expected operational change of the powertrain system based on route information describing at least one route segment 224 for an intended route of the vehicle, and determining S20, by the processing circuitry of the controller, to control the compressor assembly based on the predicted expected operational change.

Example 22. A computer program product comprising program code for performing, when executed by the processing circuitry of any of examples 1-19, the method of example 21.

Example 23. A non-transitory computer-readable storage medium comprising instructions, which when executed by the processing circuitry of any of examples 1-19, cause the processing circuitry to perform the method of example 21.

The terminology used herein is for the purpose of describing particular aspects only and is not intended to be limiting of the disclosure. As used herein, the singular forms "a," "an," and "the" are intended to include the plural forms as well, unless the context clearly indicates otherwise. As used herein, the term "and/or" includes any and all combinations of one or more of the associated listed items. It will be further understood that the terms "comprises," "comprising," "includes," and/or "including" when used herein specify the presence of stated features, integers, actions, steps, operations, elements, and/or components, but do not preclude the presence or addition of one or more other features, integers, actions, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as "below" or "above" or "upper" or "lower" or "horizontal" or "vertical" may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being "connected" or "coupled" to another element, it can be directly connected or coupled to the other element, or intervening elements may be present. In contrast, when an element is referred to as being "directly connected" or "directly coupled" to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the disclosure being set forth in the following claims.

What is claimed is:

1. A powertrain system for a vehicle, the powertrain system comprising:
an internal combustion engine operable on a gaseous fuel;
a gaseous fuel tank system having a set of gaseous fuel tanks for storing pressurized gaseous fuel, the gaseous fuel tank system being configured to be in fluid communication with the engine; and
a compressor assembly for pressurizing gaseous fuel, wherein the powertrain system is operable in a first powertrain operational mode where gaseous fuel is supplied from at least one of the gaseous fuel tanks to the engine in a non-operational mode of the compressor assembly, and in a second powertrain operational mode where gaseous fuel from at least one of the gaseous fuel tanks is pressurized by the compressor assembly in an operational mode of the compressor assembly and supplied to the engine;
wherein the powertrain system further comprises a controller configured to:
predict an expected operational change of the powertrain system based on route information describing at least one route segment for an intended route of the vehicle; and,
determine to control the compressor assembly based on the predicted expected operational change.

2. The powertrain system of claim 1, wherein determine to control the compressor assembly based on the predicted expected operational change comprises determining whether to operate the compressor assembly in the operational mode, switch from the non-operational mode to the operational mode, remain in the non-operational mode, or switch from the operational mode to the non-operational mode.

3. The powertrain system of claim 2, wherein the controller is configured to determine whether to operate the compressor assembly in the operational mode, switch from the non-operational mode to the operational mode, remain in the non-operational mode, or switch from the operational mode to the non-operational mode by determining whether operating the compressor assembly will increase or decrease powertrain system efficiency in the at least one route segment.

4. The powertrain system of claim 1, wherein the controller is configured to determine to control the compressor assembly by determining a first powertrain system efficiency for operating the powertrain system in the first powertrain operational mode in the at least one route segment and a second powertrain system efficiency for operating the powertrain system in the second powertrain operational mode in the at least one route segment, compare the first powertrain system efficiency and the second powertrain system efficiency, and select the operational mode with the determined highest powertrain system efficiency.

5. The powertrain system of claim 1, wherein the controller is further configured to predict the expected operational change of the powertrain system based on a previous powertrain system operating profile for the route segment.

6. The powertrain system of claim 1, wherein the controller is further configured to determine a current powertrain system efficiency and determine to control the compressor assembly based on a comparison with the determined current powertrain system efficiency.

7. The powertrain system of claim 1, wherein the controller is configured to predict the expected operational change of the powertrain system by determining any one of an expected operational change in engine load, engine torque, engine revolution and engine acceleration in the at least one route segment.

8. The powertrain system of claim 1, wherein the predictive information is generated based on historical route data for the intended route for the vehicle.

9. The powertrain system of claim 1, wherein the controller is further configured to prioritize the operation of the compressor assembly when the predicted expected change in the operation of the powertrain system is indicative of engine load conditions favoring increased efficiency from pressurized fuel supply.

10. The powertrain system of claim 1, further comprising a buffer tank arranged between the engine and the gaseous fuel tanks, wherein the buffer tank stores fuel compressed by the compressor assembly for use during conditions where operating the compressor assembly is predicted to decrease engine efficiency.

11. The powertrain system of claim 10, wherein the controller is configured to deplete the buffer tank prior to an anticipated engine braking event, and to operate the compressor assembly during the engine braking to refill the buffer tank without consuming additional fuel.

12. The powertrain system of claim 1, wherein the gaseous fuel is either a hydrogen-based fuel or a natural gas fuel.

13. The powertrain system of claim 1, wherein the compressor assembly is configured to at least partly be powered by the internal combustion engine, and/or wherein the compressor assembly is configured to at least partly be powered by an auxiliary power source.

14. A vehicle comprising a powertrain system according to claim 1.

15. A method for controlling a compressor assembly of a powertrain system for a vehicle, wherein the method comprises:
predicting, by processing circuitry of a controller, an expected operational change of the powertrain system based on route information describing at least one route segment for an intended route of the vehicle, and
determining, by the processing circuitry of the controller, to control the compressor assembly based on the predicted expected operational change.
